(19) United States
(12) Patent Application Publication
(10) Pub. No.: US 2014/0015914 A1
(43) Pub. Date: Jan. 16, 2014

(54) REMOTE ROBOTIC PRESENCE

(71) Applicant: Claire Delaunay, Palo Alto, CA (US)

(72) Inventor: Claire Delaunay, Palo Alto, CA (US)

(21) Appl. No.: 13/941,029

(22) Filed: Jul. 12, 2013

Related U.S. Application Data
(60) Provisional application No. 61/671,012, filed on Jul. 12, 2012.

(51) Int. Cl. H04N 7/15

(52) U.S. Cl. CPC H04N 7/15
USPC 348/14.02; 901/50

(57) ABSTRACT

A mobile robot system for video teleconferencing system is described herein. A robot can be operable by a remote user. Via the robot, a remote user can interact within a local user's environment to provide telepresence capabilities. For example, the robot can be deployed on a horizontal surface, such as a table or desktop. The robot can include a microcontroller, a drive unit, and interface to a consumer device, such as a mobile device. The drive unit can include two or more motors for providing motion capabilities. The microcontroller can be wired or communicatively coupled to the consumer device. In general, the consumer device may be a mobile phone or a tablet computer where processing power and wireless or other capabilities of these devices can be utilized by the system. The system can be based on a networking protocol providing multi-party data exchanges.

### CROSS-REFERENCE TO RELATED APPLICATIONS

This application claims the benefit of U.S. Provisional Patent Application Ser. No. 61/671,012 (Attorney Docket Number CBOTP001P) entitled “METHOD AND APPARATUS FOR TELECONFERENCING SYSTEM USING MOBILE ROBOTS”, filed on Jul. 12, 2012. The entirety of the above-noted application is incorporated by reference herein.

### BACKGROUND

As individuals collaborate or work remotely, telepresence robots are becoming more popular. Often, telepresence robots are designed to have an adult or large size in order to display an environment to a user. For example, robots may display from or around a head level perspective, such as at about a height of a human standing up. Generally, because of their size, these telepresence robots are expensive and heavy. Additionally, their size and weight implies usage of powerful motors and batteries, thereby making these telepresence robots potentially dangerous for deployment in environments involving humans. Therefore, expensive, heavy robots may not be considered suitable for general consumer usage. Additionally, robots may use proprietary protocols or interfaces to exchange remote control and video data. As a result, some robots may be used exclusively by the robot's manufacturer and respective customers. This means protocols are often non-generalizable to similar robots.

### SUMMARY

This summary is provided to introduce a selection of concepts in a simplified form that are described below in the detailed description. This summary is not intended to be an extensive overview of the claimed subject matter, identify key factors or essential features of the claimed subject matter, nor is it intended to be used to limit the scope of the claimed subject matter.

This disclosure relates to the video conferencing. For example, robots compatible with consumer electronic devices can be deployed to provide telepresence capabilities. Thus, in view of the above, methods, systems, and apparatus for providing telepresence capabilities are disclosed herein.

One or more systems or one or more methods for a telepresence system including robots or robotic teleconferencing is described herein. In one or more embodiments, a mobile base station includes one or more actuators, one or more sensors, a consumer device interface, a microcontroller board or microcontroller, and a power source. For example, one or more of the actuators can drive one or more wheels thereby adjusting or changing a position of the mobile base station or an orientation of a consumer device coupled to the mobile base station. In one or more embodiments, a mobile base station can have one or more movement components configured to move the mobile base station or a corresponding consumer device. In other words, a user, such as a remote user, can operate the mobile base station according to one or more telepresence capabilities.

The consumer device interface can be configured to receive a consumer device, such as a mobile device. When the consumer device is coupled to the mobile base station, a telepresence robot with networking, video display, audio output, or locomotive capabilities can be established. In one or more embodiments, the telepresence robot can be configured to send or transmit video streams or audio streams over a network to a remote station. These streams may be received by a remote device or remote station. Additionally, the mobile base station may receive control commands that allow features of the telepresence robot to be controlled, such as one or more locomotive capabilities. The mobile base station may receive video data or audio data that can be output on the telepresence robot, such as via a video feed showing a remote user, for example. According to one or more embodiments, a remote party or remote user can discover a first party's hardware or software configuration.

The following description and annexed drawings set forth certain illustrative aspects and implementations. These are indicative of but a few of the various ways in which one or more aspects are employed. Other aspects, advantages, or novel features of the disclosure will become apparent from the following detailed description when considered in conjunction with the annexed drawings.

### DESCRIPTION OF THE DRAWINGS

Aspects of the disclosure are understood from the following detailed description when read with the accompanying drawings. Elements, structures, etc. of the drawings may not necessarily be drawn to scale. Accordingly, the dimensions of the same may be arbitrarily increased or reduced for clarity of discussion, for example.

FIG. 1 is an illustration of an example remote robotic presence system, according to one or more embodiments.

FIG. 2 is an illustration of an example remote robotic presence system, according to one or more embodiments.

FIG. 3 is an illustration of an example remote robotic presence system, according to one or more embodiments.

FIG. 4 is an illustration of an example remote robotic presence system, according to one or more embodiments.

FIG. 5 is an illustration of an example remote robotic presence system, according to one or more embodiments.

FIG. 6 is an illustration of an example remote robotic presence system, according to one or more embodiments.

FIG. 7 is an illustration of an example remote robotic presence system, according to one or more embodiments.

FIG. 8 is an illustration of an example remote robotic presence system, according to one or more embodiments.

FIG. 9 is an illustration of an example remote robotic presence system, according to one or more embodiments.

FIG. 10 is an illustration of an example remote robotic presence system, according to one or more embodiments.

FIG. 11 is an illustration of an example remote robotic presence system, according to one or more embodiments.

FIG. 12 is an illustration of an example remote robotic presence system, according to one or more embodiments.

FIG. 13 is an illustration of an example remote robotic presence system, according to one or more embodiments.

FIG. 14 is an illustration of an example remote robotic presence system, according to one or more embodiments.

FIG. 15 is an illustration of an example remote robotic presence system, according to one or more embodiments.

FIG. 16 is an illustration of an example flow diagram of a method for remote robotic presence, according to one or more embodiments.

FIG. 17 is an illustration of an example flow diagram of a method for remote robotic presence, according to one or more embodiments.

FIG. 18 is an illustration of an example flow diagram of a method for remote robotic presence, according to one or more embodiments.

FIG. 19 is an illustration of an example flow diagram of a method for remote robotic presence, according to one or more embodiments.

FIG. 20 is an illustration of an example remote robotic presence system, according to one or more embodiments.

FIG. 21 is an illustration of an example computer-readable medium or computer-readable device including processor-executable instructions configured to embody one or more of the provisions set forth herein, according to one or more embodiments.

FIG. 22 is an illustration of an example computing environment where one or more of the provisions set forth herein are implemented, according to one or more embodiments.

FIG. 23 is an illustration of one or more views of an example mobile base station associated with a remote robotic presence system, according to one or more embodiments.

### DETAILED DESCRIPTION

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

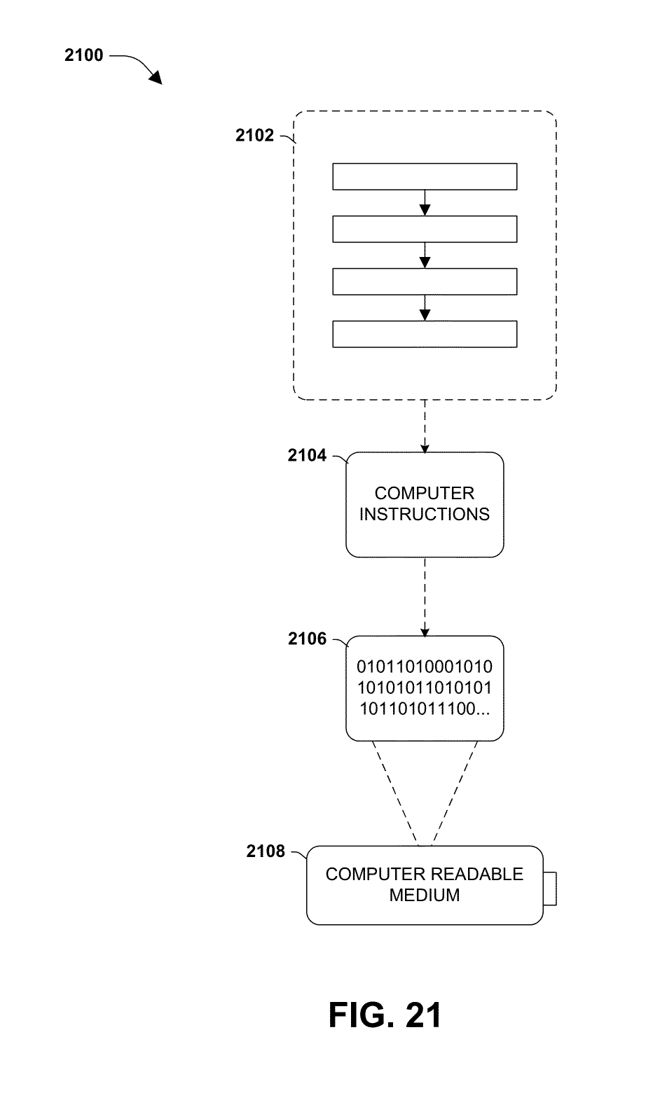

For one or more of the figures herein, one or more boundaries, such as boundary 2114 of FIG. 21, for example, are drawn with different heights, widths, perimeters, aspect ratios, shapes, etc. relative to one another merely for illustrative purposes, and are not necessarily drawn to scale. For example, because dashed or dotted lines are used to represent different boundaries, if the dashed and dotted lines were drawn on top of one another they would not be distinguishable in the figures, and thus are drawn with different dimensions or slightly apart from one another, in one or more of the figures, so that they are distinguishable from one another. As another example, where a boundary is associated with an irregular shape, the boundary, such as a box drawn with a dashed line, dotted lined, etc., does not necessarily encompass an entire component in one or more instances. Conversely, a drawn box does not necessarily encompass merely an associated component, in one or more instances, but can encompass a portion of one or more other components as well.

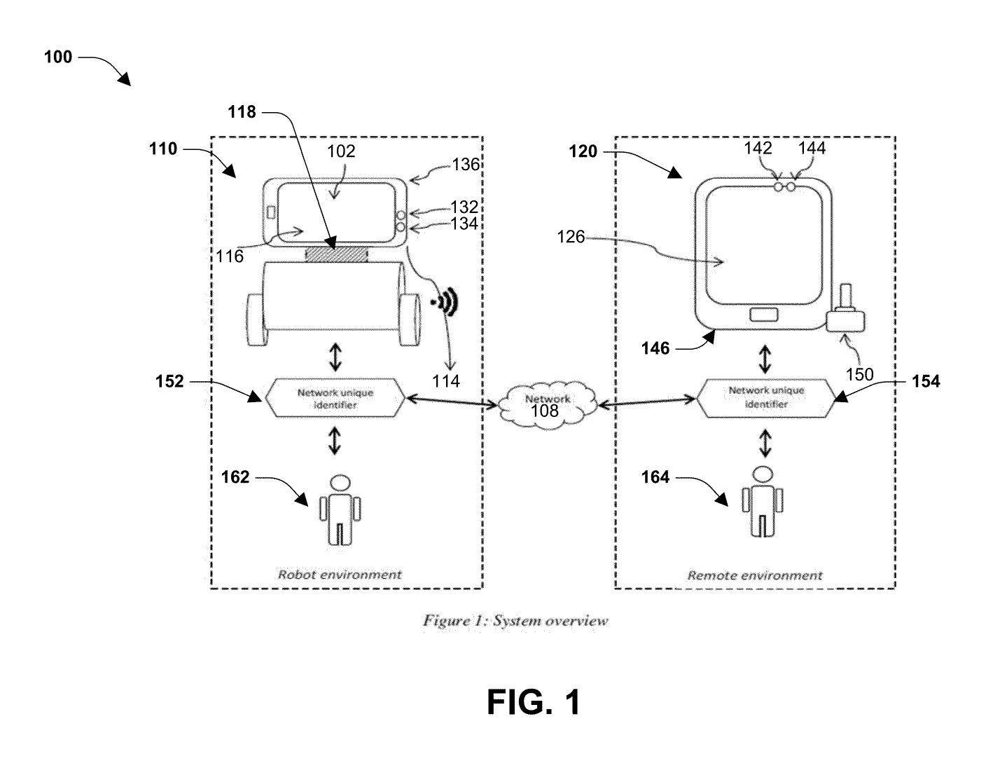

FIG. 1 is an illustration of an example remote robotic presence system 100, according to one or more embodiments. In FIG. 1, a robot 110 and a remote station 120 communicating together through a network 108 are shown. One or more connections associated with the network 108 from the robot 110 or the remote station 120 may be encrypted. The remote station 120 can send control data or commands to the robot 110 over one or more networks 108, such as a broadband network, a cellular network, etc. The robot 110 can be configured to send status data back to the remote station 120. In one or more embodiments, the robot 110 or the remote station 120 can be configured to exchange one or more video streams or one or more audio streams. This means that a user of the robot (e.g., robot user) or a user of the remote station (e.g., remote user) can view or hear the other user via one or more of the video streams or audio streams. It will be appreciated that one or more other types of data can be transmitted or received. Additionally, one or more of the audio streams or one or more of the video streams can include one or more of the other types of data.

The system 100 can be configured to utilize consumer electronic devices, such as a mobile devices, mobile phones, or tablet computers in conjunction with the robot 110. For example, a consumer device 102 can be coupled to a mobile base station 114 to form the robot 110. The robot 110 can be remotely controlled from a remote station 120, or exchange video signals or audio signals with the remote station 120 or the consumer device 102. Additionally, the remote station 120 can be a second consumer device in one or more embodiments. The robot 110 or mobile base station 114 can include one or more displays, audio output devices, processors, networking components, etc. Additionally, these components may be used alone or in conjunction with the consumer device 102.

The robot 110 can include an interface 118 that enables coupling between the robot 110 and a consumer device 102. A consumer device 102 may have a processing unit, such as an embedded processing unit (not shown). In one or more embodiments, the consumer device 102 may be a mobile phone, mobile device, a tablet, or a similar device, for example. The consumer device 102 can have one or more network capabilities or storage capabilities that can be utilized by the system 100, the robot 110, or the remote station 120. The consumer device 102 may include one or more capture components 132. Additionally, the consumer device 102 may have one or more sound input capabilities or sound output capabilities, such as a microphone 134 or one or more speakers 136. The consumer device 102 may have a screen 116 configured to display a video stream associated with or received from the remote station 120.

In one or more embodiments, the remote station 120 can be a mobile device, such as a mobile phone, a tablet, a computer, or an electronic device with processing or networking capabilities. The remote station 120 may include a video camera device 142 or capture component, a microphone 144, one or more speakers 146, one or more peripherals, or one or more sensors that enhance remote control capabilities, such as a joystick 150 or an accelerometer. The remote station 120 can include one or more display capabilities, such as a screen 126 configured to display a video stream associated with or received from the robot 110.

In one or more embodiments, robot 110 and remote station 120 can communicate based on a networking protocol. The networking protocol used in this telepresence system 100 can provide a mechanism to identify one or more entities in a unique manner. For example, using this network protocol, a robot 110 can be assigned a unique network identifier 152, such as a name. The unique network identifier 152 can be used to find the robot 110 over the network 108, and redirect one or more control commands to the robot 110. Similarly, a remote station 120 can be associated with a unique network identifier 154, such as a name. The unique network identifier 154 may allow the remote station 120 to be found on the network 108 and to receive one or more data streams from the robot 110.

Generally, one or more users (e.g., robot users 162) can be situated in an environment around a robot 110 or an environment associated with the robot 110 (e.g., robot environment). A robot user can be a human, an individual, or a virtual user, such as a monitoring program or an intelligent agent, for example. Similarly, in an environment associated with the remote station 120 (e.g., remote environment), there may be one or more users (e.g., remote users 164). As an example, a remote user 164 can issue commands to control or to actuate the robot 110, which is in the robot environment and not the remote environment. Additionally, the remote user 164 can receive incoming information from the robot 110, such as a status, a location, operating system, one or more capabilities, one or more installed applications, one or more available actions, etc.

As described above, a first consumer device 102, such as a mobile device, can be coupled to a mobile base station 114 to form the robot 110. One or more applications can be installed on the first consumer device 102 that enable the consumer device 102 to receive one or more commands from a second consumer device or a remote station 120. Additionally, the first consumer device 102 can be configured to transmit data, such as video data or audio data to the second consumer device or the remote station 120. One or more of the control commands or commands received from the second consumer device 120 may be relayed to one or more actuators in the mobile base station 114. In one or more embodiments, an application can be installed on the second consumer device or remote station 120, such as another mobile device, to enable communication to be established between the two consumer devices.

The remote station 120 or second consumer device can receive one or more inputs or one or more control inputs to control the robot 110, such as commands to move the robot in a direction from an associated input device, such as a touch screen 126. In response to one or more of the control commands received from the second consumer device, the robot 110 can change or adjust a corresponding position of the robot 110 or a position of the first consumer device 102. For example, the robot 110 can move from a first location to a second location. In one or more embodiments, video content can be received from the first consumer device 102 and output on the second consumer device 120. That is, one or more of the remote users 164 may be presented with a video feed of the movement associated with the robot 110.

Although one robot 110 and one remote station 120 are represented in this example, one or more robots or one or more remote stations are contemplated. For example, a real life scenario could include a number of remote stations connected to a number of robots. A remote station 120 could control a number of robots, and a robot 110 could be controlled by a number of remote stations. Further, several robots in the same environment could be controlled by several different remote stations, thereby enabling remote interaction between several remote users in the same environment via one or more of the robots.

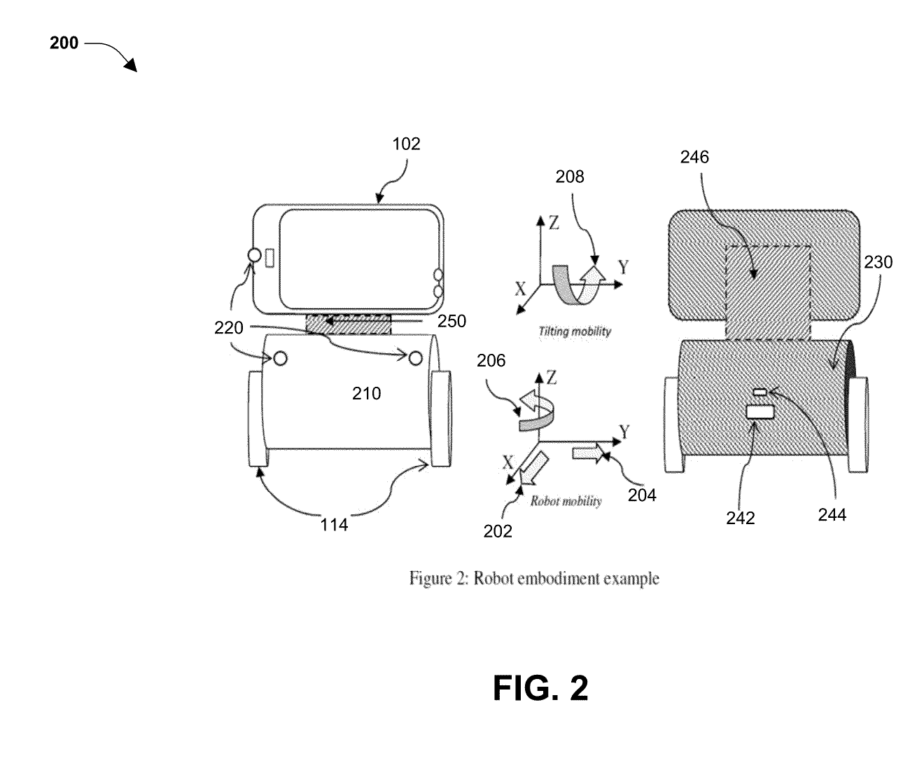

FIG. 2 is an illustration of an example remote robotic presence system 200, according to one or more embodiments. One or more details of a robotic system 200 for teleconferencing are described, such as a form factor, one or more components, or one or more sub-components of the robotic system 200. The robot system 200 of FIG. 2 can include a consumer device 102, a robot body 210, a mobile base station 114, a microcontroller 230, one or more sensors, and one or more actuators 220 attached to the body 210 or to the consumer device 102. As an example, the mobile base station 114 can include a differential drive allowing translational movement on the plane defined by an X axis and a Y axis described by 202 and 204. Additionally, the differential drive can enable rotation along the Z axis 206, for example. A tilting mechanism 250 may be configured to actuate the consumer device 102 and provide rotational capabilities (e.g., at 208) about the X axis and the Y axis 202 and 204. In one or more embodiments, the tilting mechanism 250 can be configured to adjust a view angle of a video capture device (e.g., video capture component 132 of FIG. 1) on the consumer device 102 or a display angle of a video display device or display component of the consumer device 102. One or more other drive mechanisms or tilting mechanisms with additional degrees of freedom may also be provided. This example is provided for the purpose of illustration and is not meant to be limiting.

The consumer device 102 can be attached to the body 210 of the robot with a reversible mechanism 246. The reversible mechanism can be configured to enable the consumer device 102 to be attached or detached from the robot body 210. For example, the attachment mechanism or interface 246 can be compatible with one or more consumer devices associated with a variety of form factors, weights, etc. In one or more embodiments, a magnetic holder or an adjustable mechanical clip can be included with the robot body 210 that secures the consumer device 102 in place. In addition, different interface components can be provided with the attachment mechanism 246 for enabling compatibility with one or more consumer electronic devices. For example, a first interface component can be provided that allows an iPhone™ to be coupled to the robot system 200 while a second interface component can be provided for an iPad™ to be coupled to the robot system 200.

The robot system of FIG. 2 can include a bus 242 configured to facilitate information transmission between the microcontroller 230 and the consumer device 102. The bus 242 could be a USB compatible interface or a Bluetooth compatible interface, for example. Additionally, other types of wireless or wired interfaces are possible.

In one or more embodiments, the robot system 200 of FIG. 2 can include a charging connector 244. The charging connector 244 can be configured to enable power to be provided to an internal power source within the robot system 200, such as a battery (not shown) for charging purposes, for example. The internal power source can provide power to internal actuators, such as one or more motors. In one or more embodiments, a power connector can be provided between the consumer electronic device 102 and the mobile base station 114. As an example, the power connector 244 enables the consumer device 102 to provide power that allows devices, such as actuators, on the mobile base station 114 to be operated. In other embodiments, the consumer device 102 can receive power from the mobile base station 114.

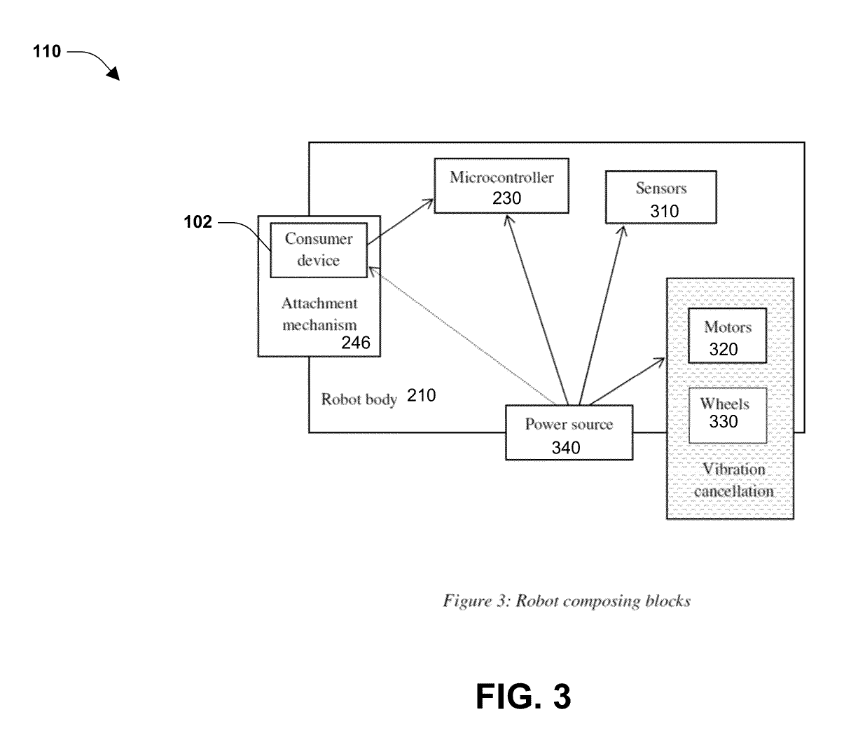

FIG. 3 is an illustration of an example remote robotic presence system 110, according to one or more embodiments. In one or more embodiments, a mobile base station (e.g., a mobile base station 114 of FIG. 1 or FIG. 2) can be configured to provide locomotion capabilities for system 110. The mobile base station can include one or more microcontrollers 230, one or more sensors 310, one or more motors 320, one or more wheels 330, one or more power sources 340, a robot body 210, and an attachment mechanism 246 which enables coupling to a consumer device 102. In one or more embodiments, the mobile base station can have one or more movement components that are configured to move the mobile base station (e.g., legs, engines, tread, or other appendages for moving, etc.).

The power source 340 may be a battery capable of powering a microcontroller 230, a microcontroller board, sensors 310, or actuators used on the robot system 110. The mobile base station's power source 340 can provide current or power to the consumer device 102, creating a system 110 powered by the robot power source 340. In other words, the robot can act as a charging station for a consumer device 102 in one or more embodiments. In one or more embodiments, the system 110 can include vibration cancellation mechanisms. This enables the system 110 to mitigate shaking when providing a video feed to one or more other users, such as remote users, for example.

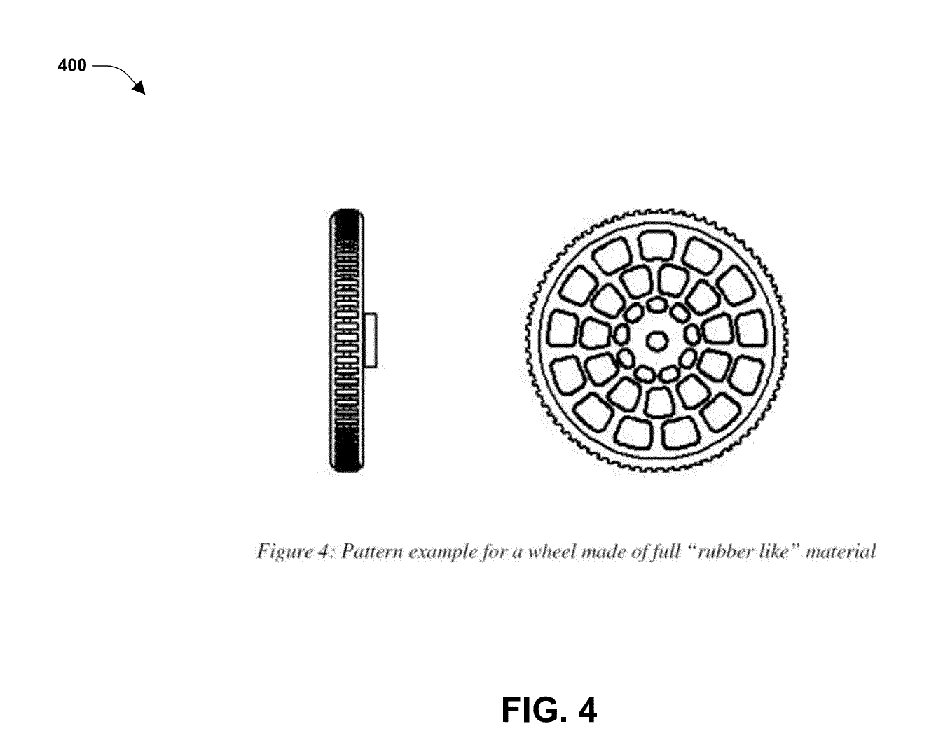

In one or more embodiments, the mobile base station can include mechanisms for mitigating vibration or noise. For example, sources of potential vibration noises like motors 320 or wheels 330 may be isolated using special equipment and materials, like silicone tabs, anti-vibration screws, or rubber wheels. An example of a wheel design can be shown in FIG. 4.

Accordingly, FIG. 4 is an illustration of an example remote robotic presence system 400, according to one or more embodiments. The wheel of FIG. 4 can have a pattern and be made of rubber like materials.

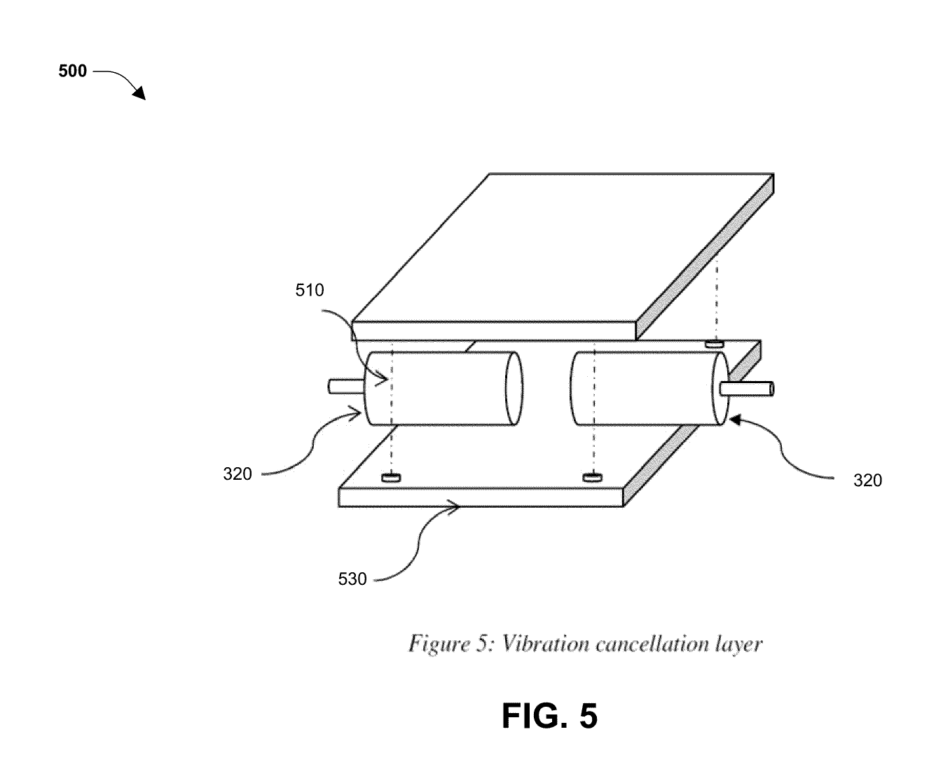

FIG. 5 is an illustration of an example remote robotic presence system 500, according to one or more embodiments. In one or more embodiments, vibration suppression or noise suppression may include a rubber layer 530 where the motors 320 are attached. This can mitigate vibration associated with one or more of the motors 320 from being transmitted to the robot body 210. Additionally, this design could mitigate an amplifying effect associated with a hollow solid housing for a robot. For example, when one or more of the motors 320 are near a microphone, noise suppression can be provided to mitigate background noise associated with one or more of the motors or movement associated with the robot. In this way, vibration suppression or noise suppression can be provided, thereby enhancing a telepresence experience for one or more users, for example.

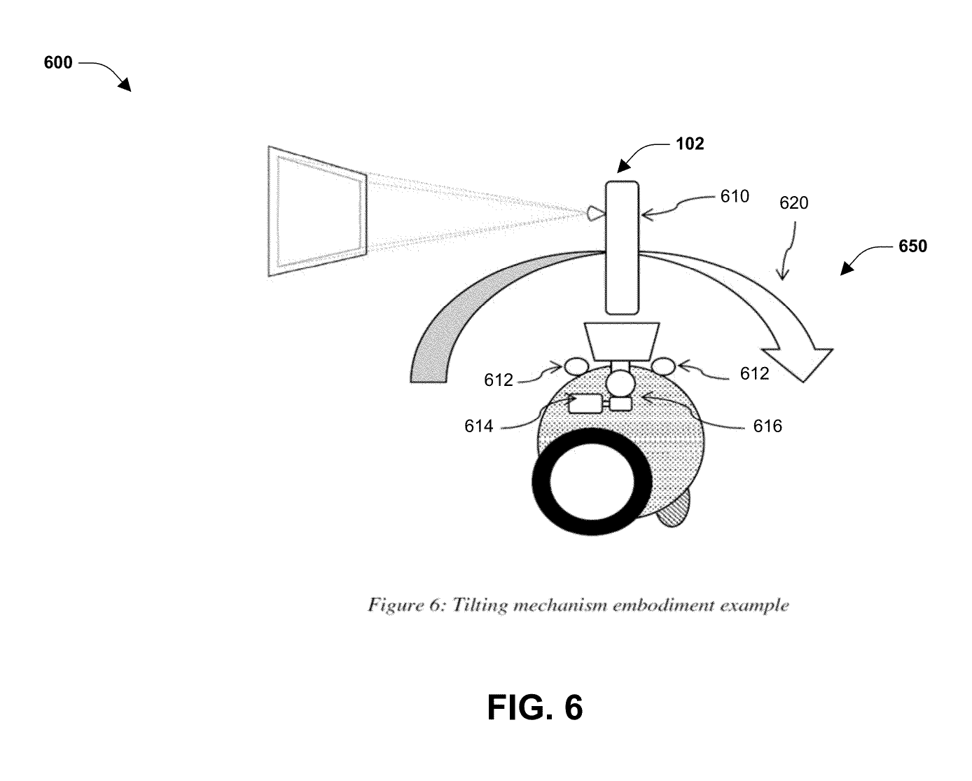

FIG. 6 is an illustration of an example remote robotic presence system 600, according to one or more embodiments. In one or more embodiments, a tilting mechanism 650 can be utilized with a robot system 600. The tilting mechanism 650 enables a consumer device 102 or associated camera to have one or more positions, such as an up position 610 or a down position 620. In one or more embodiments, the consumer device 102 can be adjusted automatically or in response to one or more commands or one or more remote commands. For example, a system 600 can utilize or include face recognition or person recognition technology that allows a person's face to be detected. In response, the robot can automatically orientate itself to the person's face by utilizing or adjusting the tilt mechanism 650. One or more efficient designs can be utilized to mitigate energy consumption while holding the consumer device 102 in place. In this way, energy may be consumed during movement to one or more of the positions, such as the up position 610 or the down position 620.

For example, when a command to orient the consumer device 102 is received, the tilt mechanism 650 may consume energy during moment to reach a new position. After a desired orientation is reached, the tilt mechanism 650 may not consume energy to hold that position. As an example, this tilt mechanism 650 could be based on a worm screw gearbox 616. Worm screw 616 can be a non-reversible type of gear and be configured to hold the weight of the consumer device 102 in place without requiring an active compensation from the motor 614. Additionally, when no encoders are used to measure the angle reached by the tilt mechanism 650, one or more sensors, such as limit sensors 612 on a side of the mechanism can be configured to detect one or more limits of rotation, such as a lower limit of rotation or an upper end of rotation.

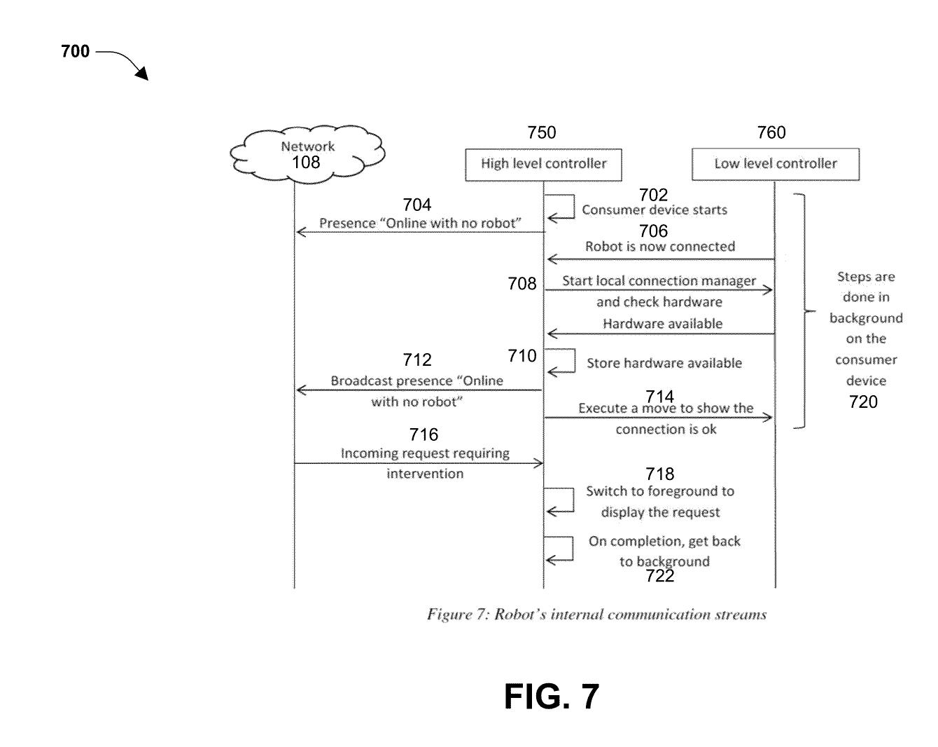

FIG. 7 is an illustration of an example remote robotic presence system 700, according to one or more embodiments. In one or more embodiments, a robot can include a high level controller 750 and low level controller 760. A consumer device implements high level controls 750 while a microcontroller board or microcontroller implements low level control 760. The high level controller 750 may be configured to start when a consumer device is turned on at 702. For example, this may cause the controller 750 to broadcast its online presence at 704 over a network. A presence packet may be set to “Online with no robot connected” if the consumer device is not yet connected to the robot. At this stage, the high level controller 750 may be run as a background task 720, meaning messages may not be displayed in relation to the consumer device.

When the robot is connected to the consumer device at 706, the high level controller 750 can automatically wake up the local connection manager unit 708, in charge of the connection between the consumer device and the microcontroller board or microcontroller. Additionally, the high level controller 750 can query the microcontroller for available sensors and actuators. This may be used by the High level controller 750 to store 710 or update an associated description of one or more robot capabilities. When the Local Connection manager is started 708, an updated presence packet can be broadcast. The presence packet can contain information indicating that the robot is available 712. In the meantime, the robot could execute a predetermined movement 714 showing that the connection of the robot to the consumer device is working correctly.

During these steps, if no external event occurs, the high level controller 750 can run in background. As an example, an event may be a request from the consumer device to open the high level controller's graphical interface. The graphical interface can be activated when the application icon is pressed, for example. In one or more embodiments, the high level controller 750 can switch from background to foreground 718 to display one or more error messages or when one or more of the error messages are detected. Another example of an external event may be an incoming request 716 for an intervention, such as a call coming from a remote user. In response to the call, the high level controller 750 can display a graphical interface to allow the management of this request, like “refuse” or “accept” and/or the name of the remote user for the call. Whenever the high level controller 750 is not expecting any intervention from the graphical interface, is may return to background 722 to enable normal usage of the consumer device. The high level controller 750 can generate a graphical interface that can be displayed when the controller 750 switches from background to the foreground. The interface may allow a human user to interact with the robot or interact with the remote station.

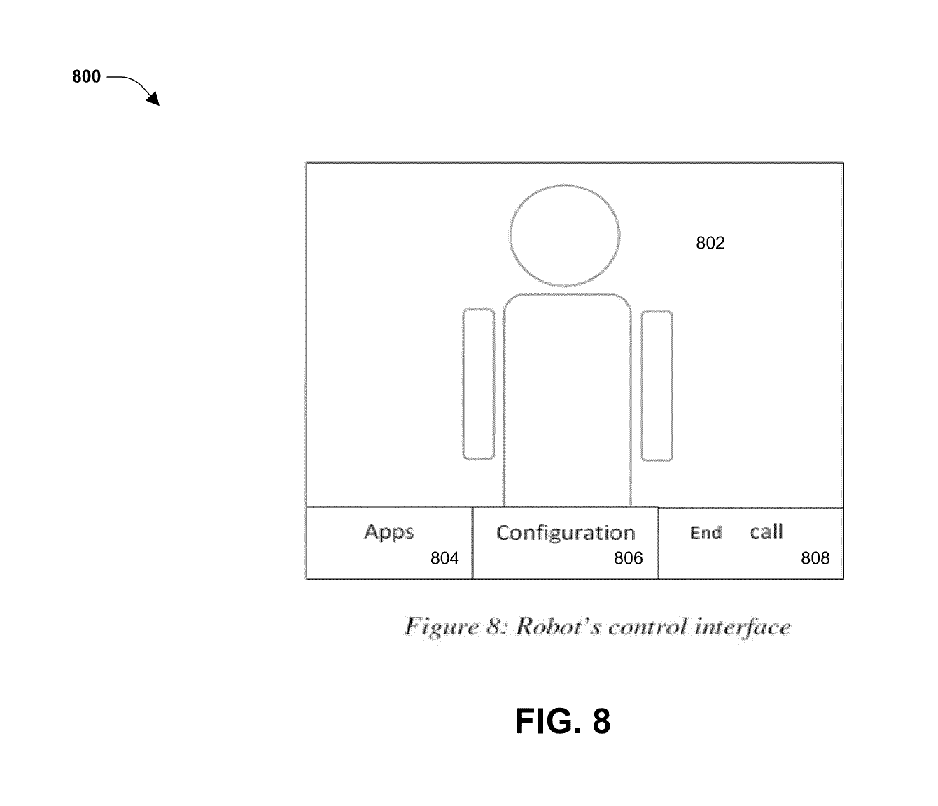

FIG. 8 is an illustration of an example robot associated with a remote robotic presence system 800, according to one or more embodiments. When a call is started, the video stream 802 of the remote user may be presented. An application can provide controls 806 to manage the current call, such as volume, camera used, or applications (apps) 804. Certain features may or may not be enabled for the remote user. The apps button can be configured to allow the local user to access features of the application and set the permissions for the remote user. An extra button can be used to end 808 the current call.

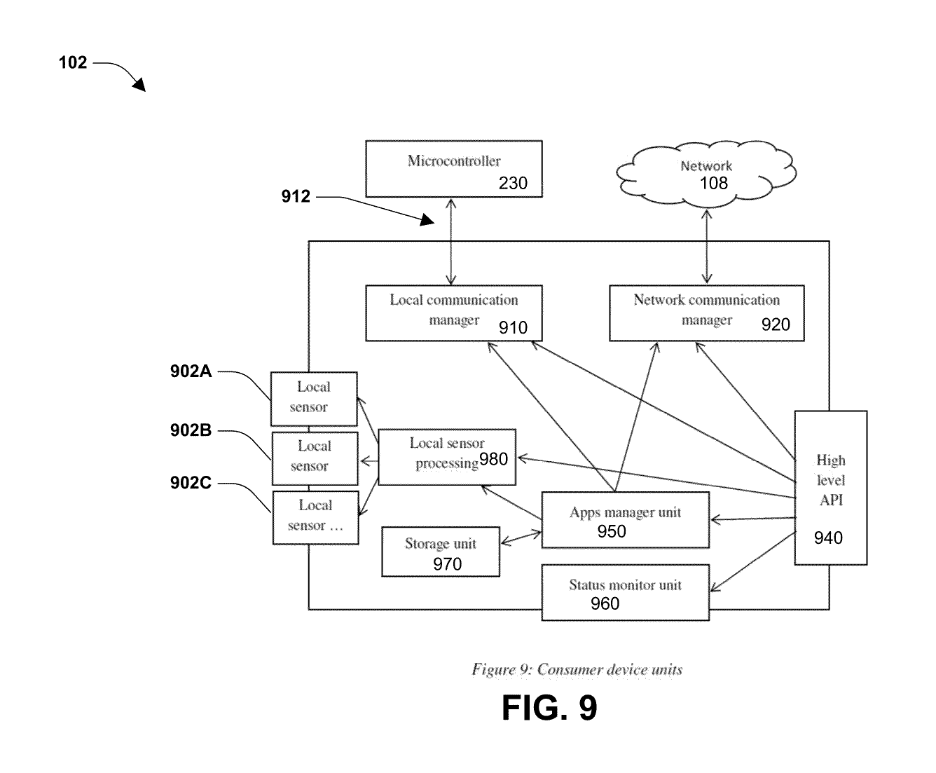

FIG. 9 is an illustration of an example remote robotic presence system 102, according to one or more embodiments. Generally, a consumer device 102 can be configured to host a high level controller, which can include one or more processing or logical units. As an example, an application can be downloaded and executed on the consumer device 102 to instantiate the high level controller. The consumer device 102 may have its own power source, such as a battery pack, and may include sensors, such as a GPS receiver, accelerometer, or camera. As described above, one or more of these features and/or mechanisms described herein associated with the consumer device 102 can also be integrated into a mobile station, mobile device station, robot, etc.

In FIG. 9, the consumer device 102 includes a bus 912 configured to exchange information with a microcontroller 230. The microcontroller 230 can be the microcontroller of a robot or a local microcontroller. As an example, a physical bus can be a USB cord or a Bluetooth adapter. A local communication manager unit 910 manages this connection. A local communication manager 910 can be a program running on the consumer device 102 managing the communication with the microcontroller 230, sending data to activate one or more actuators. Additionally, the local communication manager 910 can receive incoming data from the microcontroller 230. The consumer device 102 may have a local sensor processing unit 980, configured to gather and process the data coming from the sensors 902A, 902B, or 902C directly packaged with the consumer device 102, such as a GPS receiver or an accelerometer sensor. The collected data can be used internally or sent data back to the network communication manager 920.

The network communication manager 920 can be configured to manage network exchanges. As an example, the network manager 920 may be configured to broadcast presence information based on activation of a consumer device 102. The network manager 920 may be configured to collect information about the presence of authorized remote users. The network manager 920 may be configured to establish or disconnect calls or data connections. Additionally, the network manager 920 may be configured to filter one or more incoming packets or trigger actions in response.

Downloaded apps can be stored locally on a storage unit 970. The apps manager unit 950 can store descriptive information related to one or more of the apps that are currently installed on the consumer device 102. An app may be saved with information related to ownership and the how an app may be executed. The apps manager unit 950 can execute one or more apps at a time, schedule them, stop them, etc. By querying this unit 950, it can be possible to know which apps are currently in use and schedule them or interrupt them.

A status monitor unit 960 can be configured to track a state of one or more components for the system 102. The status monitor unit 960 may fires periodically according to a configurable frequency and can also be activated externally by events, such as a sudden network interruption. The status monitoring unit 960 can be configured to take action in response to an anomaly. Information about an action can be relayed through the network communication manager 920 to inform remote users. In addition, a local warning using consumer device capabilities, such as playing a sound or displaying a message can be triggered. The status monitoring unit 960 may be configured to trigger an automatic shutdown of sensitive tasks like the robot movement.

According to one or more aspects, the status monitor unit 960 can be configured to notify one or more parties about changes in network quality, such as bandwidth, signal strength regarding a communication connection, such as a wireless signal strength. This provides users with information impacting a current tele-operation experience. For example, a user can use the information to help them to make choices, such as stopping the connection or moving to a higher quality connection.

The application program interface (API) 940 can provide an interface configured to enable interaction with one or more presented units. In one or more embodiments, the API 940 may be configured to interact with a consumer device 102. Functionalities offered via the API 940 can be either private or public. When functions are public, it can be possible for everyone to use this functionality in order to create one or more apps.

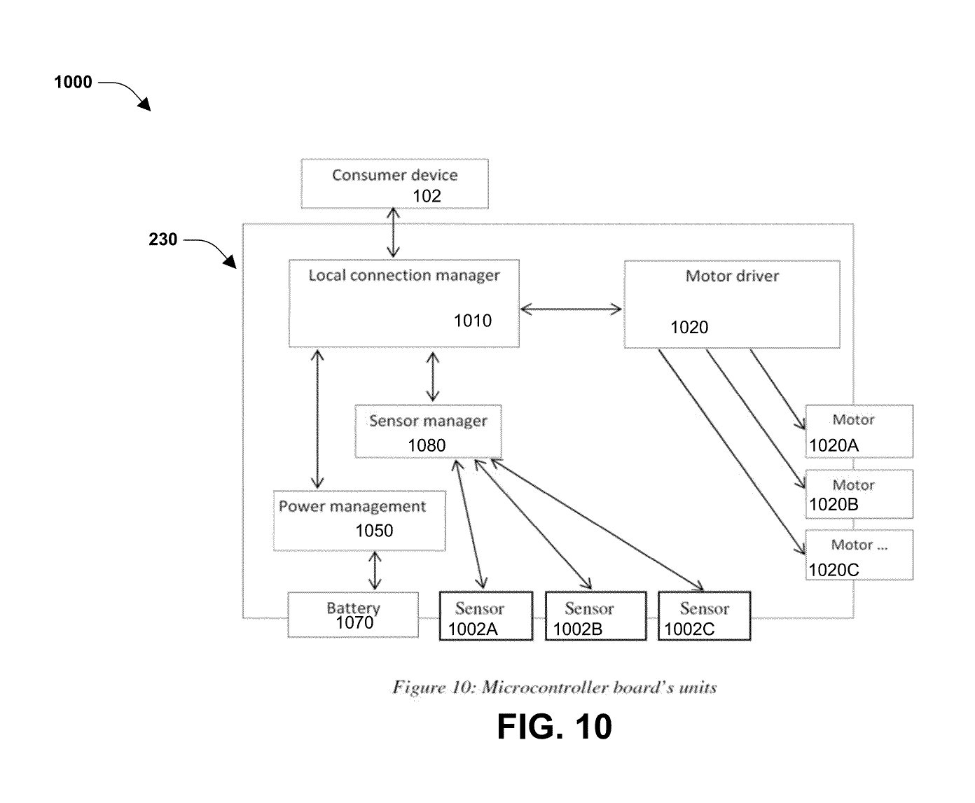

FIG. 10 is an illustration of an example remote robotic presence system 1000, according to one or more embodiments. FIG. 10 illustrates an example of a microcontroller board 230 that can be utilized in a mobile base station. The microcontroller board 230 can be an electronic system providing low level processing capabilities. Low level processing capabilities can be the way the electrical signals are sent to one or more motors, or the way a sensor can send information about a sensor state, using voltage modulation. Various sensors or actuators can be connected to the microcontroller board 230.

The microcontroller 230 or microcontroller board may host a connection manager unit 1010 configured to handle the connection to the consumer device 102. This connection manager unit 1010 can be coupled with a physical bus that connects the consumer device 102 to the microcontroller 230. A physical bus could include a wired connection or a wireless connection. For example, the physical bus can be a Universal Serial Bus (USB) or a Bluetooth compatible BUS.

The microcontroller 230 may contain a power management unit 1050, which may be configured to provide intelligent energy management capabilities. The power management unit 1050 can be configured to decide whether or not to redirect power to the consumer device 102 or to put the microcontroller board 230 and one or more sensors 1002A, 1002B, 1002C, etc. in sleep mode to conserve energy when actions or sensing are not in usage.

The microcontroller board 230 may include one or more motor drivers 1020. A motor driver 1020 may be an electronic circuit or software logic that enables one or more actuators, such as one or more motors 1020A, 1020B, 1020C, etc. to be driven. The motor driver 1020 can be configured to send or transmit one or more commands to one or more of the motors 1020A, 1020B, 1020C, etc. The motor driver 1020 can be configured to provide current limiting functions, such as, for example to mitigate battery draining when a motor is stalled.

A sensor manager unit 1080 can configured to monitor information received from one or more sensors 1002A, 1002B, 1002C, etc. The sensor manager unit 1080 can use the data coming from the sensor in two different ways. For example, the sensor manager unit 1080 can be configured to forward the information or raw information to a consumer device 102. As another example, the sensor manager unit 1080 can be configured to implement the information at a microcontroller level. This behavior can be useful to implement reflexes directly into the microcontroller 230 instead of relaying them to the consumer device 102 and waiting for an action to be computed by the consumer device 102. A local reflexive action can be automatic braking, such as when a sensor has detected an obstacle or a drop-off, such as the edge of a table, for example.

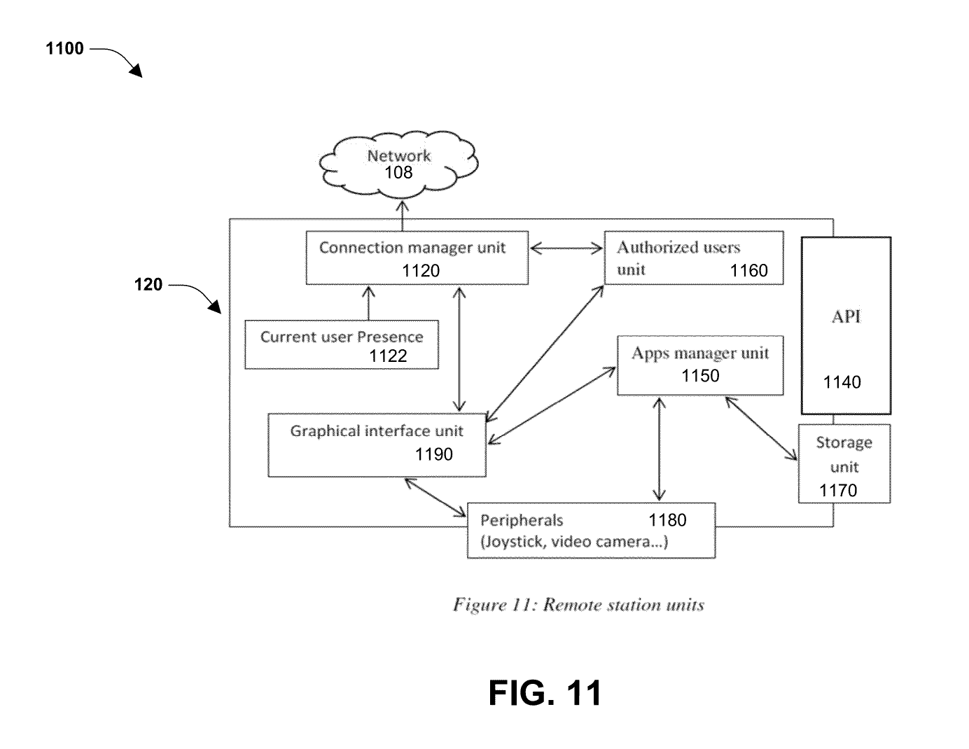

FIG. 11 is an illustration of an example remote robotic presence system 1100, according to one or more embodiments. A remote station 120 enables a user to remotely control one or more robots over a network 108. A remote station 120 can be a program running on a processing device such as a computer, a tablet, a mobile device, or other processing device with networking capabilities, such as an application downloaded to a mobile device. FIG. 11 illustrates a block diagram of a remote station 120.

The connection manager unit 1120 handles incoming requests by dispatching them to one or more relevant units, and sending or transmitting one or more outgoing streams. The connection manager unit 1120 may be configured to send or transmit regularly a current presence 1122 or updating the current presence 1122 accordingly. The authorized users unit 1160 may be configured to maintain a list of authorized users including a current known presence status. For example, a current known presence status can be whether a user is available for a telepresence session, such as ‘available’ or ‘not available’. The authorized users unit 1160 may be configured to determine if a user has a robot and whether or not the robot is connected. The authorized users unit 1160 can be configured to send or transmit information to the Graphical Interface Unit 1190. This enables a graphical user interface (GUI) to be updated to reflect a status of a user.

An apps manager unit 1150 can be configured to handle or manage one or more apps, such as locally stored apps. One or more of the apps may enable functions associated with the robotic telepresence system 1100. Apps may be pre-installed with the remote station package, or downloaded and installed afterward. When an app is installed, the cap can be stored on the remote station storage unit 1170. A copy of a configuration file corresponding to an installed app can be sent to the Apps manager unit 1150. This configuration file can be implemented for one or more apps and can be based on a predetermined format usable by the apps manger unit 1150 to determine one or more requirements of one or more of the apps and how to execute one or more of the apps. The Apps manager unit 1150 can be configured to start, execute, or interrupt one or more apps installed on the remote station 120.

One or more peripherals 1180 can be connected to the remote station 120, such as for generating one or more control inputs. For example, a peripheral can be a video camera device, a joystick, an accelerometer, etc. In one or more embodiments, a peripheral can be “required” by an app. This means, the apps manager unit 1150 may ensure this peripheral 1180 is available before installing the application, indicating the application is available, or before running the application. The presence of a peripheral 1180 can trigger specific widget to display on the graphical interface, to inform any human user about the presence and status of this peripheral 1180. As an example, a peripheral can be a widget for plotting in real time, the acceleration of an embedded accelerometer.

The API 1140 can provide an interface configured to enable interaction with one or more presented units. Additionally, the API 1140 may enable interaction with a consumer device. Functionalities offered by the API 1140 can be private or public. When functions are public, it can be possible for everyone to use this functionality in order to create one or more apps. The graphical interface unit 1190 can be configured to generate a main interface for a human operator to have a representation of a current status and to interact with robots. Several modes may be available depending on the state of the current user.

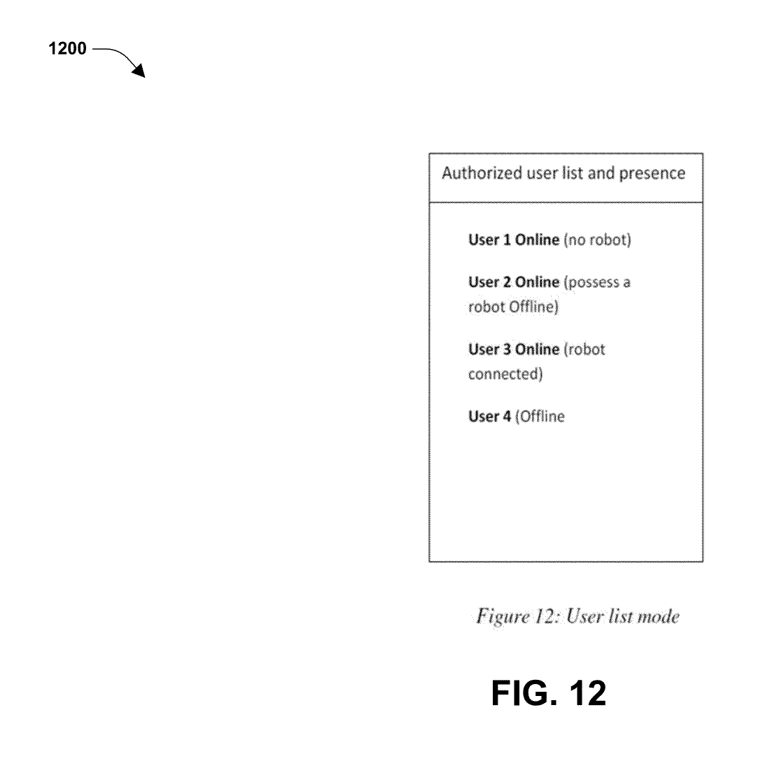

FIG. 12 is an illustration of an example remote robotic presence system 1200, according to one or more embodiments. For example, FIG. 12 illustrates a graphical interface example of a remote station in “User list Mode”. If a current user is “Online” or not in a call, the display mode can be set to “User list mode”. In “User list mode”, a list of authorized users can appear. For each user on the list, there can be a set of actions available according to their status. For example, if a user's presence is “Online with a robot”, a remote control call may be enabled or presented as an option. If the presence is “Online with no robot”, a voice call or a video call may be enabled. Additionally, a message may be sent requesting a connection a robot.

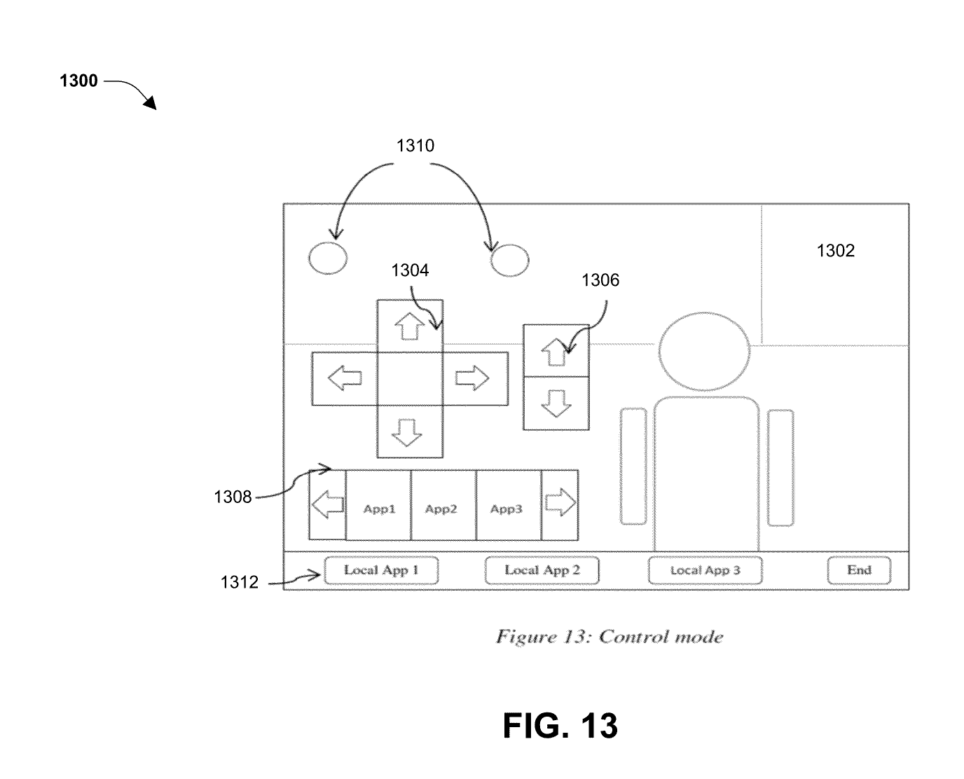

FIG. 13 is an illustration of an example remote robotic presence system 1300, according to one or more embodiments. FIG. 13 is an illustration of an example graphical interface of a remote station in “Control Mode”. If a current user is “Online” and in a call with a robot configured for remote control, the graphical interface can be updated to a “Control Mode” interface. The “Control mode” interface can display one or more controls or one or more control panels based on a distant robot configuration or local capabilities of the distant robot. For example, if a call can be made to a robot with video, a stream may be displayed on dedicated video rendering panel 1302. Additionally, when a robot has motion capabilities, a panel may appear to control robot's movements, such as four buttons 1304 to control movement over an X, Y plane. As another example, the user interface of FIG. 13 may use the video stream received from a robot as a driving interface. An input from a remote user, such as a mouse click or a touch screen event can be used to calculate a displacement from the actual point of view of the robot to the one indicated by the user. Similarly, a tilting mechanism available on the robot can be controlled with an adapted widget 1306. An adapted widget could be arrowed buttons indicating the direction of the movement, or a widget based on a motion. Additionally, the adapted 1306 widget may be configured to enable an up/down gesture motion on a touch screen device.

The remote graphical interface of FIG. 13 may be configured to display one or more available apps on the robot. In one or more embodiments, automatic detection of one or more remote apps can be part of a telepresence protocol, thereby enabling a remote user to view one or more options which may be available on the robot. For example, detection may be based on a current remote user network identity or one or more permissions attributed to one or more of the apps. As an example, a panel 1308 could be configured to display one or more apps available on the remote robot with one or more icons. Other incoming data, such as sensory information from the robot may be displayed according to their format, such as infrared sensors by one or more lights 1310.

In one or more embodiments, local apps shortcuts 1312 may be accessible within the interface. Local apps may be programs installed on the remote station to enable a predefined set of actions to be executed. Local apps may include a control algorithm or advanced artificial intelligence programs. For example, apps meeting one or more the requirements may be displayed at 1312. That is, if a joystick is not present but needed by app, the app may not be displayed at 1312, for example.

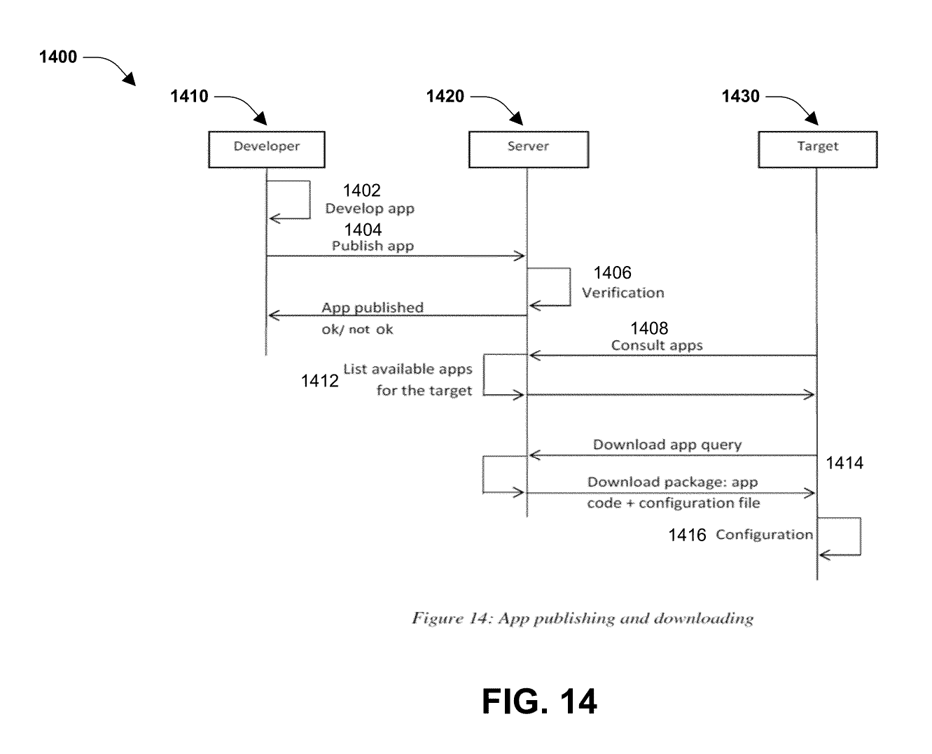

FIG. 14 is an illustration of an example remote robotic presence system 1400, according to one or more embodiments. Generally, apps may be downloadable extensions that provide robots or remote stations with one or more functionalities or capabilities. An example of an app running on the robot may be an automatic movement detection app, allowing the robot to automatically track people or individuals moving in the robot's proximity. An app running on the remote station may be an automatic facial expression recognition app that reflects automatically recognized expression on remote user face with a robot predefined movement.

Apps may be developed 1402 based on API function calls. Separate APIs may exist for robot side and for remote station application development. These APIs may expose public functions in order to allow apps to be developed. A developer 1410 may use the APIs to program an app. When done, the developer may publish 1404 the app on a server 1420. The server 1420 can be a physical computer on the network or a cluster of several machines. After verification 1406, the app may be published or declined. If the app is accepted, the app may be available for other users, such as robot users or remote station users.

A target 1430 can be a robot or a remote station. When a target 1430 contacts the server 1420 to obtain a list of available apps, an automatic filtering can be applied in order to limit the visible apps 1412 to the target 1430. This filter may, for example, take as criteria the kind of target, robot or remote station, but other information insuring the app can be compatible with target such as Operating System (iOS, Android, Windows, Mac OSX, . . . ), robot capabilities (tilting mechanism enabled, locomotion mechanics based on 2 motors, 4 motors, . . . ), or remote station capabilities, such as a special joystick, a number of video cameras, a 3D display, etc. When the target 1430 is querying the server 1420 to download 1414 an app, the server 1420 may answer by sending the executable code of the app or a configuration file identifying the app and its options. A user of the target 1430 may configure this app by providing editable parameters of this configuration file 1416.

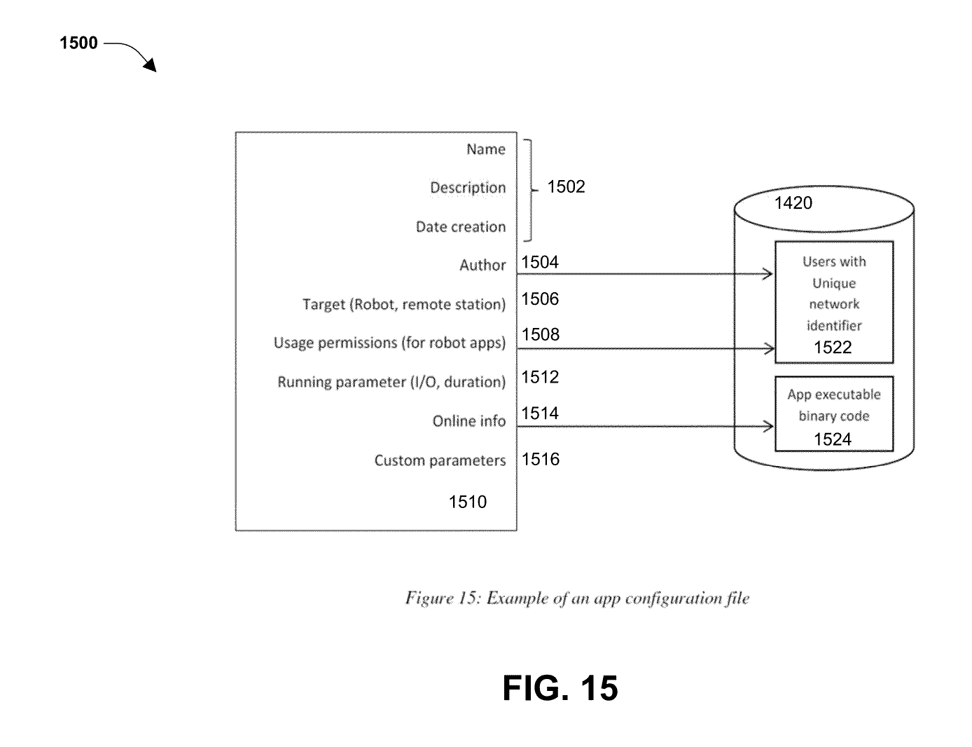

FIG. 15 is an illustration of an example remote robotic presence system 1500, according to one or more embodiments. FIG. 15 illustrates an example of one or more fields for a configuration file 1510 of an app. One or more of these fields may be coupled with the information stored in server 1420. A field can contain information about the functionality of an application and one or more requirements associated with the application. The configuration file may utilize various descriptive 1502 fields such as a name, a description, date of creation, etc. These fields should be filled before the app submission on the server 1420.

An author field 1504 may link to a user's Unique Network Identifier 1522. The target field 1506 may indicate where this app can be installed. As an example, a target may be a “robot” or a “remote station”, and the target field 1506 could specify a type of Operating System or a type of robot the application may be compatible with. Permissions field 1508 may be a list of Network Unique Identifiers or unique network identifiers allowed to use the application. For example, the permissions field 1508 can link a number of users or a set of users to “all”. This parameter may be used when a target field 1506 is “Robot”, because a remote station may be configured to discover apps installed on a robot. Accordingly, the permissions field 1508 parameter may be used to restrict visibility of an app to one or more users when installed on a robot.

Running parameters 1512 may be utilized to help an Apps manager unit run an app. For example, parameters may be custom parameters that are defined by the app author. Running parameters 1512 may describe one or more Inputs/Outputs of one or more of the apps. For example, Infrared sensors or joystick may be defined as an input, and motors may be defined as an output. Before starting an app, a unit manager may ensure one or more of these Inputs or Outputs are satisfied.

Online info 1514 may point to app online content, which usually includes an app presentation page, with descriptive information, a rating, a download link, etc. Custom parameters 1516 may be defined by an app developer. For example, a custom parameter may include a maximum speed, a music preference, a personal preference, such as a voice synthesizer preference, etc.

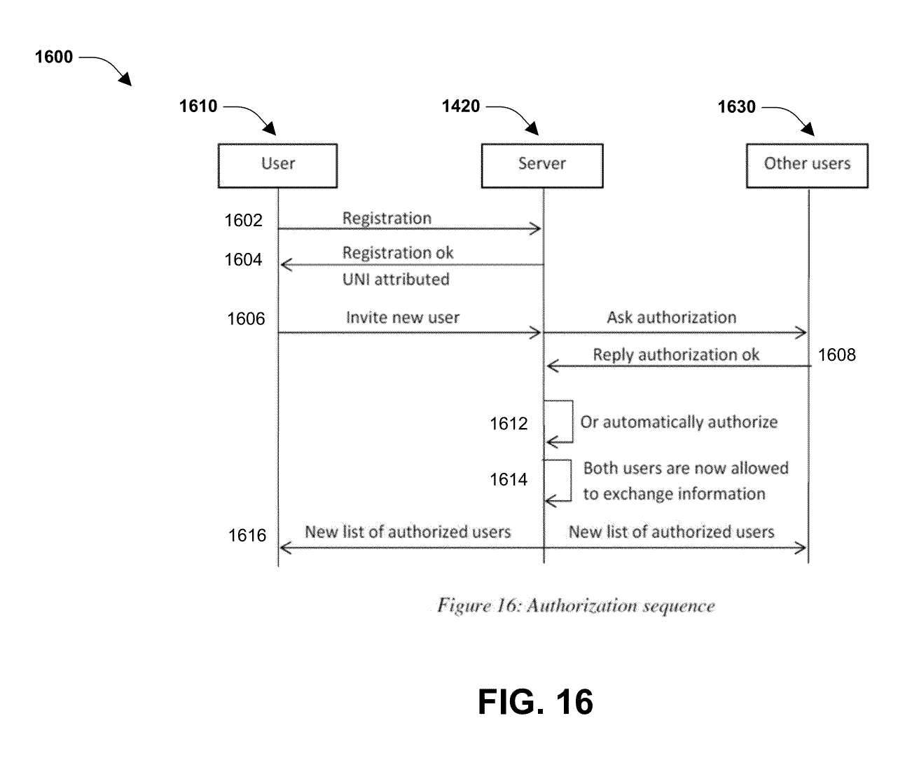

FIG. 16 is an illustration of an example flow diagram of a method 1600 for remote robotic presence, according to one or more embodiments. One or more users registered on a telepresence network may be linked together via one or more authorization links. A user may be an entity, robot, or remote station, connected to the telepresence network. A user may send or receive information over a network. At 1602, registration can occur for a user 1610. For example, the user may be assigned or attributed a Unique Network Identifier 1604, thereby providing the user with a unique address on the network. By default, it may not have any authorized user for which to exchange information. As long as the user has a valid Unique Network Identification, this user may request authorization to communicate with other users 1630.

In order to establish communications, a request 1606 can be sent to a server 1420 managing the identities and the authorizations. This server 1420 can forward the request to the specified user who can be able to decline or accept the request 1608. According to its configuration, a server may automatically authorize 1612 the request without sending the request. When the request can be accepted by either the requested user or the server itself, users are now authorized to exchange data 1614. An accepted configuration may mean that a remote station user can be now able to control a robot. Server would then broadcast the authorization information back to the involved users 1616.

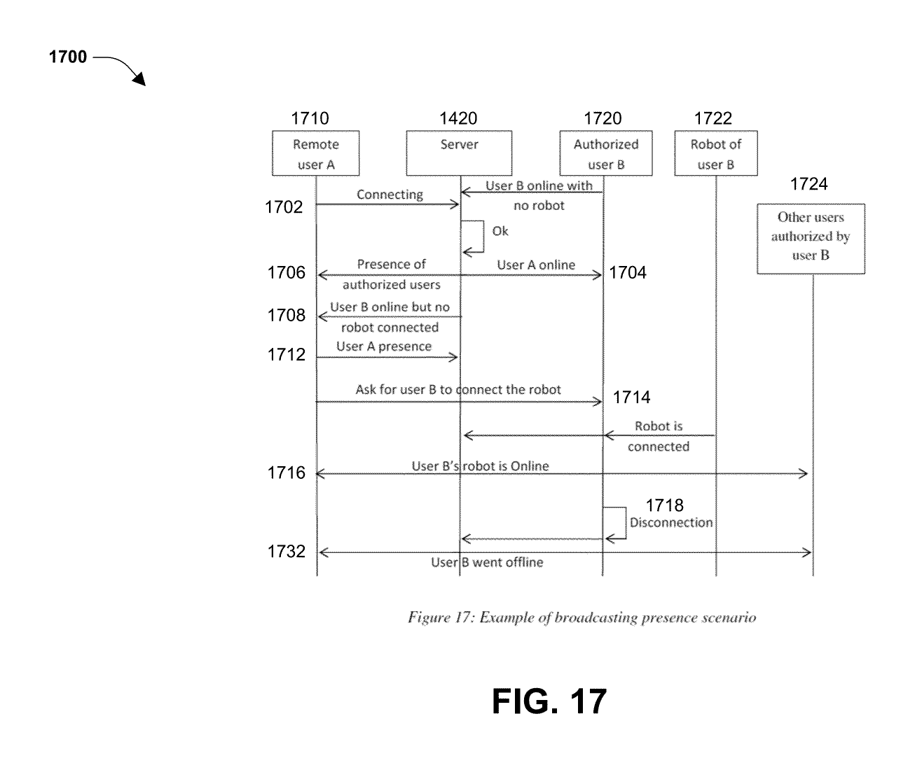

FIG. 17 is an illustration of an example flow diagram of a method 1700 for remote robotic presence, according to one or more embodiments. One type of data that may be exchanged between authorized users 1710 and 1720 (e.g., remote user A and authorized user B) can be a presence packet. When two users are authorized to communicate together, they can exchange information about respective statuses from the moment they are connected 1702 to the network until the moment they are disconnected 1718. When the remote station is turned on, it may automatically connect to the server 1702, transmitting User A's identity 1710 upon connection. When the connection is established, the remote station may start broadcasting 1712 a remote station presence periodically.

The server may respond or answer by sending or transmitting “User A” presence status to online users authorized to communicate with “User A” 1704. Similarly, “User A” may receive a packet 1706 including a list of authorized users and one or more associated presence packets. Additionally, when “User B” is disconnected, such as when User B's consumer device is turned off, an updated presence packet may be broadcast to authorized users 1732. In this example, “User B's” authorized users may not necessarily be the same users as “User A's” authorized users.

The packet may contain the “User B's” identity and presence information 1708. In an example, the User B can be a robot. The user B can be online, but not the robot. This may mean that the consumer device can be on, but not connected to the robot. This scenario may happen when the consumer device has more utility or usages than controlling the robot. For example, a mobile device may be used most of the time used for phone capabilities.

After receiving information about authorized users, User A may decide to choose an action available for a user. In the example below, User A has the presence information “Available with no robot” 1708 for user B. User A may decide to ask the User B to connect the robot 1714. If User B connects and turns on the User B robot, an updated status may be broadcasted staging User B's status “Online with a robot connected” 1716.

A user can be a robot or a remote station. From a network protocol point of view, differences between the two types of users include different set of statuses available and the requests they can handle. As an example, Table 1 shows a set of presence details for a remote user.

TABLE 1
Remote station user's status

| Remote station user | Description |
|---|---|
| Online | A remote user is Online and may call |
| | Authorized Online robots |
| Offline | The remote station is turned Off, and |
| | network communications are disabled |
| Custom status | The status is set to Online but gives |
| | additional information like waiting for a |
| | robot to be available |

Status available for robots may define distinct status information regarding the consumer device and the robot status. This distinction may be helpful to promote users to connect a consumer device to a robot. Table 2 shows an example a set of possible status for robot's users.

TABLE 2
Remote station user's status

| Robot user | Description |
|---|---|
| User does have a robot | User and robot are online, a call can |
| with a robot online | be placed |
| User Online with a robot | This status allows a remote user to |
| offline | ask to connect the robot |
| User Online with a robot | Call cannot be placed, but a |
| in use | notification can be made |
| User offline | No call can be placed, but if a |
| | remote user ask for a connection a |
| | counter might increment on the |
| | server |

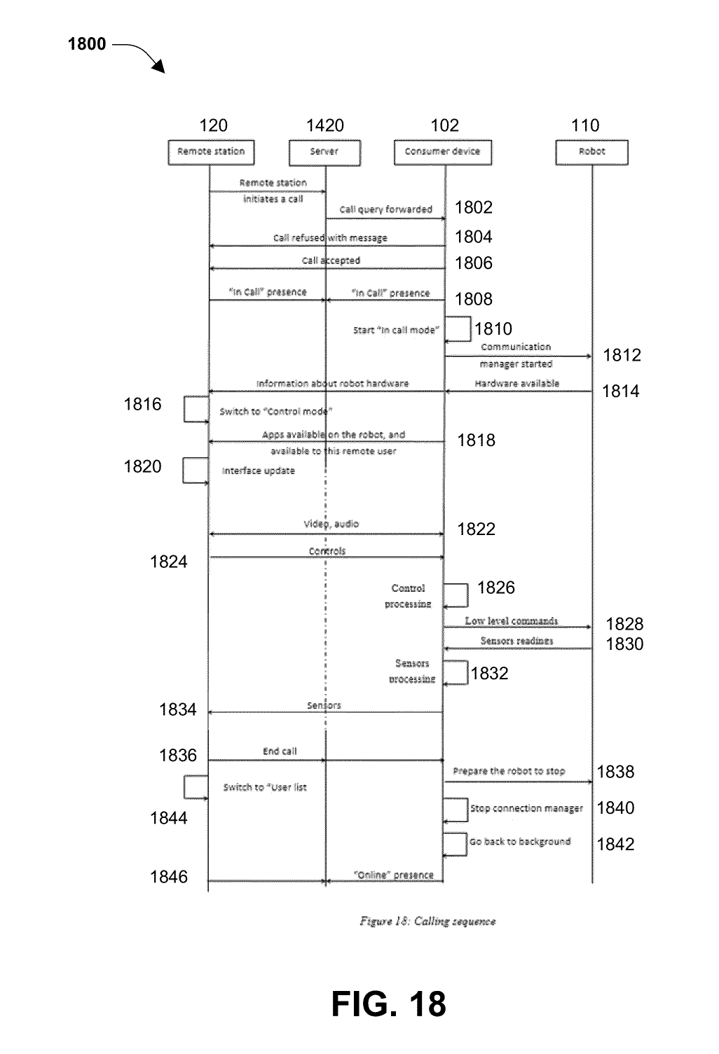

FIG. 18 is an illustration of an example flow diagram of a method 1800 for remote robotic presence, according to one or more embodiments. A remote control call may be a conversation between remote users and robots. A remote control call could involve one or more remote users and one or more robots. Generally, the sequence described can involve a remote station 120 and a robot 110. Typically, a call may imply a server 1420. A server 1420 may be a physical machine or a cluster of servers replicating or sharing and updating a common database. The party representing the robot may include two entities, such as a consumer device 102 and robot 110 to illustrate data exchange between the consumer device 102 and the robot 110 based on the call status.

A call may be initialized based on an initialization sequence. A call may be initiated by a robot or by remote station. The request for a call may be sent to the server 1420. The server 1420 may forward the call to a target user. The targeted user may then refuse 1804 or accept the call 1806. If the call is refused 1804, a message may be sent back to the initiator of the call to notify the initiator of the refusal 1804. If the call is accepted, both parties can have their status updated as being “In Call”, for example. Additionally, this change in status or status can be broadcast to respective authorized users.

Upon establishing communication between the robot 110 and the remote station 120, the consumer device 102 may start its local communication manager 1812, and collect information about the robot's hardware. The updated information about the hardware may then be sent to the remote user 1814. When the remote station gathers information to display the current call information, the remote station interface may switch to “control mode” 1816. This mode can be triggered, for example, by the reception of information about the robot's hardware. The consumer device 102 may send at a moment during a call, information regarding available apps 1818 installed on the robot. The list sent to the remote interface may include apps that the remote user is allowed to use or is capable of using. A verification operation may be done on the consumer device 102, comparing remote user network identity against app permissions. When a description of an app is sent, the remote station may update accordingly at 1820.

During a call, various types of information may be exchanged between the entities such as video, audio 1822, controls 1824, and sensory 1834 data via one or more channels. The consumer device 102 may be processing 1826 the high level commands received from the remote user into low levels commands 1828 understandable for the microcontroller. In the meantime, the microprocessor unit may send data 1830 to the consumer device, for example, sensor readings, battery levels, etc. The consumer device can eventually transform the data 1832 into another format or send data directly to the remote user. As described above, an application may have been downloaded and installed on the consumer device to enable these functions.

Call termination may be initiated by the remote user or by the consumer device to end a call, for example. A call termination event signals to each party or user to shut down the communication channel 1836. On the robot's side, call termination may trigger actions 1838 such as turning the robot into energy saving mode, or fold the tilting device, or stopping the connection manager 1840, and returning the high level controller to the background 1842. The remote station 120 may use this event to close the call and prevent the station from sending more controls. The remote station 120 may switch back to “User list mode” 1844. After these operations, the users' presence may change back to the “available” or to the status set before the call. Again the change in the device status, i.e., it can be available for communications can be broadcast 1846.

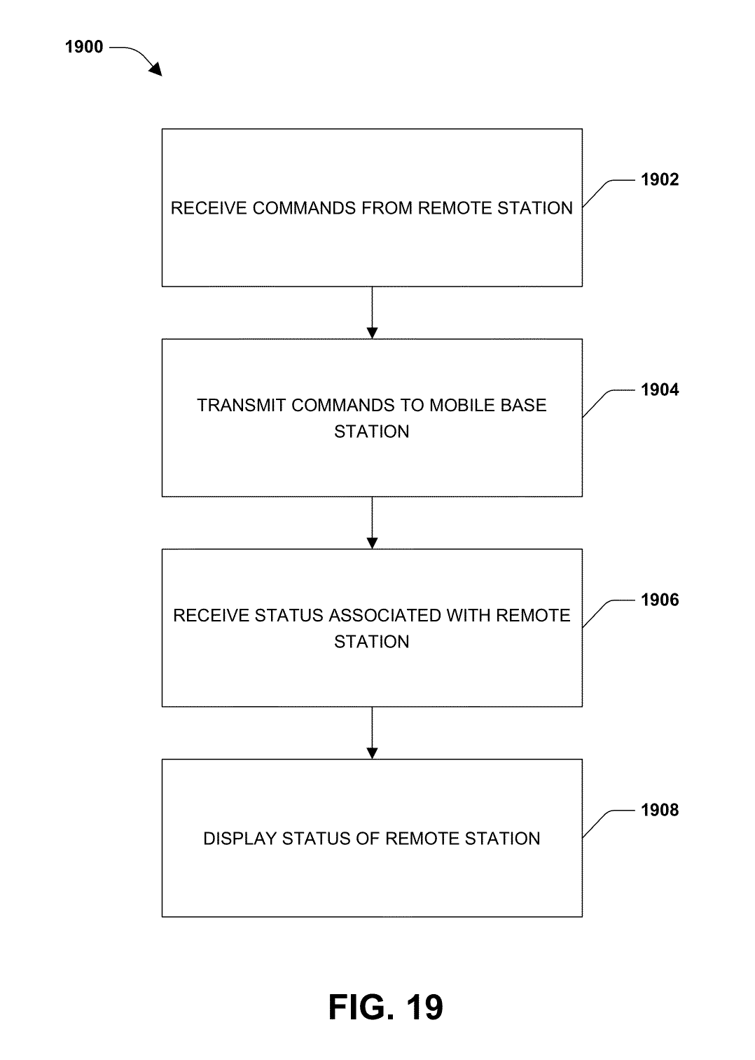

FIG. 19 is an illustration of an example flow diagram of a method 1900 for remote robotic presence, according to one or more embodiments. At 1902 one or more commands may be received from a remote station. At 1904, one or more of the commands may be transmitted from the remote station to a mobile base station. At 1906, a status associated with the remote station may be received. At 1908, status associated with the remote station may be displayed.

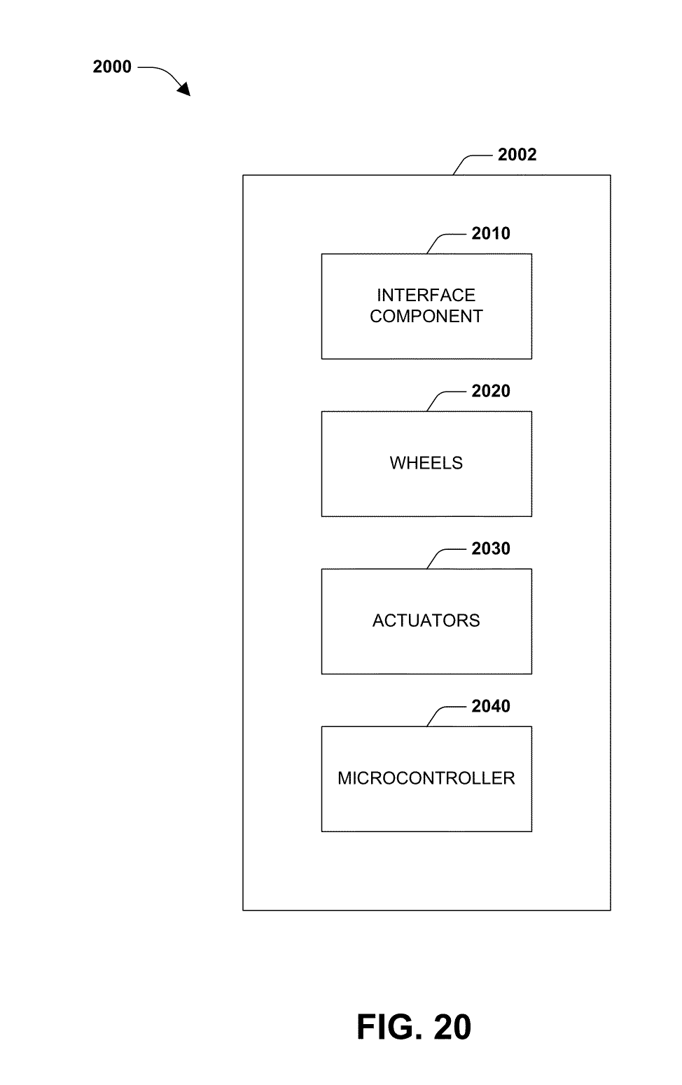

FIG. 20 is an illustration of an example remote robotic presence system 2000, according to one or more embodiments. The system 2000 can include a mobile base station 2002. The mobile base station can include an interface component 2010 configured to accept a consumer device, one or more wheels 2020, one or more actuators 2030, and a microcontroller 2040. The microcontroller 2040 can be configured to adjust one or more of the actuators 2030 or one or more of the wheels 2020 based on one or more commands received by the consumer device.

Still another embodiment involves a computer-readable medium including processor-executable instructions configured to implement one or more embodiments of the techniques presented herein. An embodiment of a computer-readable medium or a computer-readable device that is devised in these ways is illustrated in FIG. 21, wherein an implementation 2100 includes a computer-readable medium 2108, such as a CD-R, DVD-R, flash drive, a platter of a hard disk drive, etc., on which is encoded computer-readable data 2106. This computer-readable data 2106, such as binary data including a plurality of zero's and one's as shown in 2106, in turn includes a set of computer instructions 2104 configured to operate according to one or more of the principles set forth herein. In one such embodiment 2100, the processor-executable computer instructions 2104 are configured to perform a method 2102, such as the method 1800 of FIG. 18 or the method 1900 of FIG. 19. In another embodiment, the processor-executable instructions 2104 are configured to implement a system, such as the system 100 of FIG. 1. Many such computer-readable media are devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

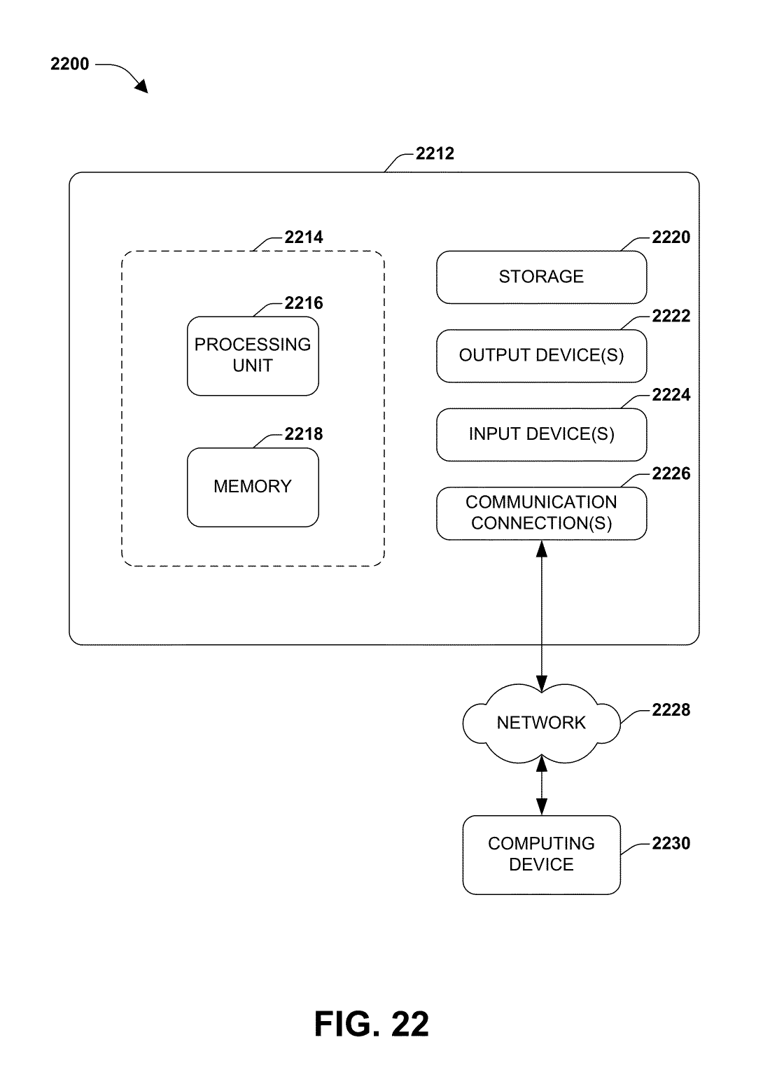

FIG. 22 and the following discussion provide a description of a suitable computing environment to implement embodiments of one or more of the provisions set forth herein. The operating environment of FIG. 22 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions are implemented as program modules, such as functions, objects, Application Programming Interfaces (APIs), data structures, and the like, that perform particular tasks or implement particular abstract data types. Typically, the functionality of the computer readable instructions are combined or distributed as desired in various environments.

FIG. 22 illustrates a system 2200 including a computing device 2212 configured to implement one or more embodiments provided herein. In one configuration, computing device 2212 includes at least one processing unit 2216 and memory 2218. Depending on the exact configuration and type of computing device, memory 2218 may be volatile, such as RAM, non-volatile, such as ROM, flash memory, etc., or a combination of the two. This configuration is illustrated in FIG. 22 by dashed line 2214.

In other embodiments, device 2212 includes additional features or functionality. For example, device 2212 also includes additional storage such as removable storage or non-removable storage, including, but not limited to, magnetic storage, optical storage, and the like. Such additional storage is illustrated in FIG. 22 by storage 2220. In one or more embodiments, computer readable instructions to implement one or more embodiments provided herein are in storage 2220. Storage 2220 also stores other computer readable instructions to implement an operating system, an application program, and the like. Computer readable instructions are loaded in memory 2218 for execution by processing unit 2216, for example.

The term “computer readable media” as used herein includes computer storage media. Computer storage media includes volatile and nonvolatile, removable and non-removable media implemented in any method or technology for storage of information such as computer readable instructions or other data. Memory 2218 and storage 2220 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 2212. Any such computer storage media is part of device 2212.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 2212 includes input device(s) 2224 such as keyboard, mouse, pen, voice input device, touch input device, infrared cameras, video input devices, or any other input device. Output device(s) 2222 such as one or more displays, speakers, printers, or any other output device are also included in device 2212. Input device(s) 2224 and output device(s) 2222 are connected to device 2212 via a wired connection, wireless connection, or any combination thereof. In one or more embodiments, an input device or an output device from another computing device are used as input device(s) 2224 or output device(s) 2222 for computing device 2212. Device 2212 also includes communication connection(s) 2226 to facilitate communications with one or more other devices.

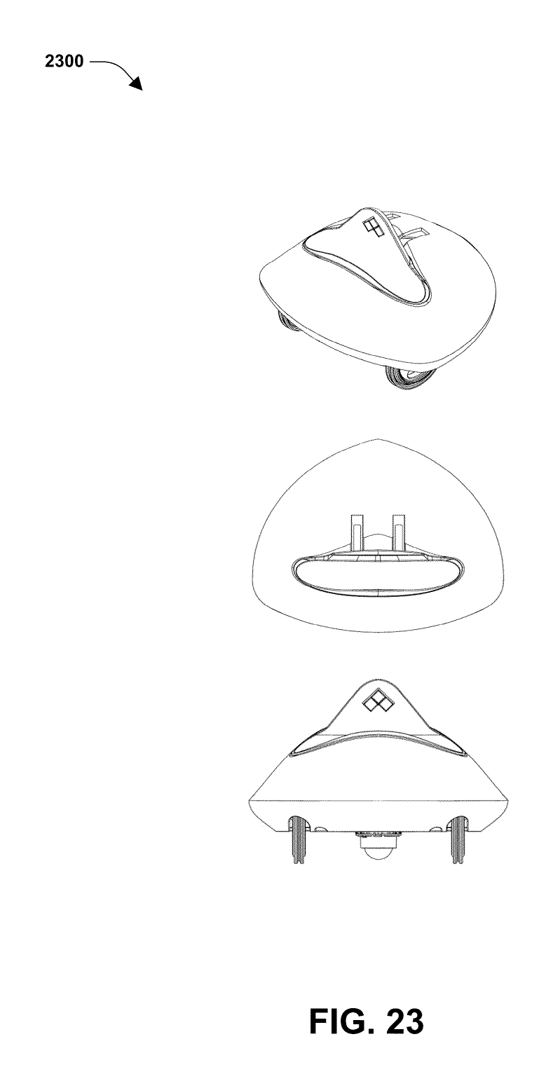

FIG. 23 is an illustration of one or more views of an example mobile base station 2300 associated with a remote robotic presence system, according to one or more embodiments.

According to one or more aspects, a remote robotic presence system is provided, including a mobile base station. The mobile base station can include an interface component configured to accept a consumer device, one or more wheels or movement components, one or more actuators, one or more sensors, and a microcontroller configured to adjust one or more of the actuators or one or more of the wheels based on one or more commands received by the consumer device or one or more microcontroller level commands. For example, one or more of the microcontroller level commands may be implemented automatically or without communication with the consumer device. In one or more embodiments, a remote station can be a second mobile base station coupled to a second consumer device.

The mobile base station can include a tilting mechanism configured to rotate the mobile base station or the consumer device. Additionally, the mobile base station comprising a communication component configured to receive or transmit one or more commands. The mobile base station can include one or more sensors configured to transmit or receive sensory information from a robot environment. For example, autonomous actuations or autonomous sensing may be enabled such that no command is received. In other words, the sensing can be automatic, such as to detect a brightness level to compensate for glare or darkness, for example. In one or more embodiments, the remote robotic presence system includes the consumer device. It will be appreciated that the remote station may be configured similarly to the consumer device with respect to any capabilities disclosed herein. Additionally, the mobile base station can include a power source configured to provide power to the consumer device, one or more of the wheels, one or more of the actuators, or the microcontroller. In one or more embodiments, the mobile base station can include a communication component configured to transmit or receive one or more commands, data, or information associated with the consumer device, the mobile base station, or the remote robotic presence system.

According to one or more aspects, a remote presence system is provided, including a robot. The robot can include a mobile platform or a mobile base station that enables a consumer device to be docked to a portion of the robot, such as the mobile base station portion, for example. In one or more embodiments, the robot has a local connection manager configured to determine one or more hardware capabilities associated with the robot, the mobile platform, the mobile base station, etc. The local connection manager may be queried, for example, by a remote station to provide one or more of the hardware capabilities to the remote station. In other words, the local connection manager may be configured to communicate with one or more external components to describe what the robot or the mobile base station may be capable of. Stated another way, the local connection manager can provide one or more available options or resources for one or more other users or parties, for example.

Additionally, the local connection manager can enable remote actuation of the robot via a docked or connected consumer device. In one or more embodiments, the consumer device may be connected to the robotic base station via a wireless connection, such as Bluetooth, for example. That is, the consumer device may not necessarily be physically coupled with the mobile base station. For example, the consumer device may rest in a holder on the mobile base station. In one or more embodiments, one or more network connections may be provided between the consumer device, the mobile base station, the robot, or the remote station. This enables transmission or receiving of one or more data streams between the consumer device, the mobile base station, the robot, or the remote station. In other words, the consumer device may transmit a video data stream to the remote station, which then receives the video data stream and displays the video data stream for one or more remote users. Similarly, the remote station may transmit a second video data stream to the consumer device, which then receives the second video data stream and displays the second video data stream for one or more robot users. In this way, two or more way video, audio, or data streams may be provided.

In one or more embodiments, the interface component of the mobile base station can include a head and the body of the mobile base station can have wheels, for example. The head may have one or more degrees of freedom and the wheels may provide one or more additional degrees of freedom. The wheels may be configured to have vibration dampening material or technology in or around the body of the mobile base station, as to mitigate noise or vibration associated with operation of the robot. In one or more embodiments, the consumer device, the mobile base station, the robot, or the remote station can have or be assigned a unique identifier or unique network identifier, wherein a unique network identifier enables a respective unit to have a unique identity over a network, for example. Similarly, a stream or data stream represented by one or more commands sent or transmitted from the remote station to the consumer device may be transmitted into movements by the consumer device translating these commands into instructions that the microcontroller. This enables the robot to understand, comprehend, or react to one or more of the commands. Additionally, the robot could sense data from the environment, such as in an ongoing manner, and transmit the data to the consumer device. The consumer device can transmit this data or data stream to the remote station.

In one or more embodiments, one or more of the unique network identifiers or unique network identifiers can be associated with a status of the consumer device, the mobile base station, the robot, or the remote station. This status may be published, such as by a communication component or an interface component over a network, to inform one or more other parties (e.g. robot party, robot user, remote party, remote user, etc.) of the status. In other words, a mobile platform, the consumer device, the mobile base station, the robot, or the remote station may be able to describe a condition or a status associated with the mobile platform, the consumer device, the mobile base station, the robot, the remote station or other mobile platforms, consumer devices, mobile base stations, robots, or remote stations.

According to one or more aspects, a remote robotic presence system is provided, including a consumer device. The consumer device can include a communication component configured to mate with a mobile base station, thereby enabling communication between the consumer device and the mobile base station. The consumer device can have an application component configured to transmit or receive one or more commands or data from a remote station. Additionally, the consumer device can have a local communication manager configured to route one or more of the commands or the data to the communication component to enable a robotic presence based on a connection between the consumer device and the mobile base station.

The consumer device can include a network communication manager configured to transmit or receive data or one or more of the commands or the data across a network. In one or more embodiments, the consumer device can include an application program interface (API) configure to enable interaction between a user and the consumer device. Further, the consumer device can include a storage unit configured to store one or more applications installed on the consumer device. The consumer device can include one or more local sensors configured to receive sensory information from a robot environment or a consumer device environment. The consumer device can be configured to manage one or more applications of the consumer device. In one or more embodiments, the consumer device can include a status monitor unit configured to monitor a state of the consumer device, a state of one or more components of the consumer device, a state of the remote robotic presence system, or a state of one or more units of the consumer device. The status monitor unit can be configured to broadcast or transmit one or more of the states, such as the state of the consumer device, for example.

A process may allow for development, download, or installation of one or more “apps” or software giving new capabilities to the mobile base, the consumer device, the remote station, the robot, the mobile base station, etc. It will be appreciated that one or more of these devices, stations, components may initiate an installation or request for data on behalf of one or more of the other devices. That is, for example, the remote station may be configured to install one or more applications on the mobile base station or the consumer device to facilitate an enhanced robotic presence. Conversely, the consumer device may be configured to install one or more applications on the remote station, etc. Similarly, a process may allow development, download, or installation of new “apps” or software giving new capabilities to the remote base, remote station, etc. In one or more embodiments, configuration information may be transmitted or received between the mobile base, the consumer device, the remote station, the robot, the mobile base station, etc. This means that any of the devices, stations, components may ‘be aware’ of hardware configurations or software configurations of one or more of the other devices, stations, components, thereby enabling a system to act accordingly.

According to one or more aspects, a method for remote robotic presence is provided, including receiving data or one or more commands from a remote station, transmitting data or one or more of the commands from the remote station to a mobile base station, receiving a status associated with the remote station, and displaying the status associated with the remote station. The method can include receiving a status associated with another remote station, wherein the other remote station authorized receiving of the status or receiving data from the mobile base station or the consumer device.

The method may include establishing a line of communication between the remote station and the mobile base station, receiving one or more data streams from the remote station, transmitting one or more data streams to the remote station, or transmitting consumer device information to the remote station, wherein the consumer device information is indicative of an operating system of a consumer device, software available to the consumer device, a hardware configuration of the mobile base station, or one or more capabilities associated with the consumer device. In one or more embodiments, one or more of the commands received or transmitted is based on a networking protocol. The method can include installing software on the mobile base station or a consumer device. The method can include installing software on the remote station.

According to one or more aspects, a method for remote robotic presence is provided, comprising transmitting data to a consumer device and receiving a status associated with the consumer device or a mobile base station coupled with the consumer device. The method can include establishing a line of communication between a remote station and the mobile base station or the consumer device. The method can include receiving available software on the consumer device or the mobile base station. In one or more embodiments, the method includes transmitting or receiving one or more data streams to or from the consumer device or the mobile base station. Additionally, the method can include publishing a presence status associated with a remote station or receiving configuration information, wherein the configuration information is indicative a hardware configuration of the mobile base station.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel.

Also, although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

What is claimed is:

1. A remote robotic presence system, comprising:
a mobile base station, comprising:
an interface component configured to accept a consumer device;
one or more movement components;
one or more actuators;
one or more sensors; and
a microcontroller configured to adjust one or more of the actuators or one or more of the wheels based on one or more commands received by the consumer device or one or more microcontroller level commands.

2. The system of claim 1, the mobile base station comprising a tilting mechanism configured to rotate the mobile base station or the consumer device.

3. The system of claim 1, the mobile base station comprising a communication component configured to receive or transmit one or more commands or data.

4. The system of claim 1, wherein one or more of the sensors are configured to transmit or receive sensory information from a robot environment.

5. The system of claim 1, the remote robotic presence system comprising the consumer device.

6. The system of claim 1, the mobile base station comprising a power source configured to provide power to the consumer device, one or more of the wheels, one or more of the actuators, or the microcontroller.

7. The system of claim 1, the mobile base station comprising a communication component configured to transmit or receive one or more commands, data, or information associated with the consumer device, the mobile base station, or the remote robotic presence system.

8. A remote robotic presence system, comprising:
a consumer device, comprising:
a communication component configured to mate with a mobile base station, thereby enabling communication between the consumer device and the mobile base station;
an application component configured to transmit or receive one or more commands or data from a remote station; and
a local communication manager configured to route one or more of the commands or the data to the communication component to enable a robotic presence based on a connection between the consumer device and the mobile base station.

9. The system of claim 8, the consumer device comprising a network communication manager configured to transmit or receive data or one or more of the commands or the data across a network.

10. The system of claim 8, the consumer device comprising an application program interface (API) configure to enable interaction between a user and the consumer device.

11. The system of claim 8, the consumer device comprising a storage unit configured to store one or more applications installed on the consumer device.

12. The system of claim 8, the consumer device comprising one or more local sensors configured to receive sensory information from a robot environment or a consumer device environment.

13. The system of claim 8, the consumer device configured to manage one or more applications of the consumer device.

14. The system of claim 8, the consumer device comprising a status monitor unit configured to monitor a state of the consumer device, a state of one or more components of the consumer device, or a state of one or more units of the consumer device and broadcast the state of the consumer device.

15. A method for remote robotic presence, comprising:
transmitting data to a consumer device;
receiving a status associated with a mobile base station coupled with a consumer device or a status associated with another remote station; and
receiving data from the mobile base station or the consumer device.

16. The method of claim 15, comprising establishing a line of communication between a remote station and the mobile base station or the consumer device.

17. The method of claim 15, comprising receiving available software on the consumer device or the mobile base station.

18. The method of claim 15, comprising transmitting or receiving one or more data streams to or from the consumer device or the mobile base station.

19. The method of claim 15, comprising publishing a presence status associated with a remote station.

20. The method of claim 15, comprising receiving configuration information, wherein the configuration information is indicative a hardware configuration of the mobile base station.
